(19) United States
(12) Patent Application Publication
(10) Pub. No.: US 2026/0291933 A1
(43) Pub. Date: Sep. 24, 2026

(54) SYSTEM

(71) Applicant: SoftBank Group Corp., Tokyo (JP)

(72) Inventor: Rio JINGU, Tokyo (JP)

(73) Assignee: SoftBank Group Corp., Tokyo (JP)

(21) Appl. No.: 19/567,351

(22) Filed: Mar. 16, 2026

(30) Foreign Application Priority Data
Mar. 19, 2025 (JP) 2025-044980

(51) Int. Cl. H04L 9/40; G06F 16/9032

(52) U.S. Cl. CPC H04L 63/083; G06F 16/90332

(57) ABSTRACT

A system includes a processor that is configured to acquire location information of a user and trigger an event when the user reaches a specific location, control an artificial intelligence device that provides a hint to the user by using a generative AI model, and transmit a question from the user to the generative AI model as a prompt and generate a response.

### CROSS-REFERENCE TO RELATED APPLICATION

This application is based on and claims priority under 35 USC 119 from Japanese Patent Application No. 2025-044980 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional interactive systems that utilize artificial intelligence to support users in location-based or game environments typically provide static or predefined hints, and do not flexibly adapt the content of assistance based on a user's current position, behavior, and free-form questions. In many cases, event triggering based on a user's location and dialogue-based support using AI are implemented as separate mechanisms, resulting in fragmented user experiences and limited immersion. In addition, existing systems often rely on manually scripted responses or fixed dialogue trees, which restrict the variety and relevance of responses to user questions, and make it difficult to efficiently design large-scale or complex game scenarios. Furthermore, there is insufficient integration between the acquisition of user location information, the control of an artificial intelligence device that appears or acts at specific locations, and the dynamic generation of prompts and responses by a generative AI model. Accordingly, there is a need for a system that seamlessly links user location detection, event triggering, and AI-based dialogue so that highly contextual hints and responses suitable for the user's situation can be automatically generated and provided in real time.

### SUMMARY

In order to solve the above-described problems, a system according to one aspect of the present invention comprises a processor, wherein the processor is configured to acquire location information of a user and trigger an event when the user reaches a specific location, control an artificial intelligence device that provides a hint to the user by using a generative AI model, and transmit a question from the user to the generative AI model as a prompt and generate a response. In one embodiment, the processor is configured to generate a prompt by using the generative AI model in response to the question from the user, and to generate the response based on the prompt, whereby the content and style of the prompt can be automatically adapted to the current context of the user, including the user's position, progress, and past interactions. In another embodiment, the processor is configured to enable the user to participate in an in-game event by causing the user to receive, through interaction with the artificial intelligence device, the response based on the prompt generated by using the generative AI model, so that the user can advance the game or scenario while engaging in natural dialogue with the artificial intelligence device. By integrating location-based event triggering, control of the artificial intelligence device, and prompt/response generation by the generative AI model in this manner, the system can provide highly immersive, context-aware assistance and interactive experiences that dynamically adapt to each user's situation.

The term “system” refers to an arrangement of hardware and software components, including at least one processor and associated devices, that collectively implement the functions recited in the claims.

The term “processor” refers to a hardware device or a combination of hardware and software, such as a CPU, GPU, microcontroller, or processing circuitry, that executes instructions to perform the operations described in the claims.

The term “location information” refers to data indicating a position of a user in a physical or virtual space, such as coordinates, positional indices, or other information that allows determination of where the user is located.

The term “user” refers to a human operator or player who interacts with the system, moves within a physical or virtual environment, and provides inputs such as questions or commands.

The term “event” refers to an action, state change, or process executed by the system in response to a condition, including but not limited to the appearance or activation of an artificial intelligence device or the presentation of a hint.

The term “specific location” refers to a defined position or region in a physical or virtual space at which, or upon entry to which, the system is configured to trigger an event.

The term “artificial intelligence device” refers to a device, component, or software-controlled entity that is controlled by the processor and that interacts with the user by providing information, hints, or dialogue, and that operates using an artificial intelligence technique such as a generative AI model.

The term “generative AI model” refers to a machine learning model, such as a large language model or other generative model, that is configured to generate text, instructions, or other outputs in response to input data including prompts from the processor.

The term “hint” refers to an informational message, suggestion, or clue provided to the user by the artificial intelligence device, using the generative AI model, to assist the user in making a decision, solving a problem, or progressing in a game or scenario.

The term “question” refers to an input from the user, expressed in natural language or another form, that seeks information, clarification, or assistance and that is transmitted to the generative AI model as a basis for generating a response.

The term “prompt” refers to text or other structured data supplied to the generative AI model, including at least the question from the user and optionally additional context, which conditions the generative AI model to produce a corresponding response.

The term “response” refers to output data generated by the generative AI model based on a prompt, including but not limited to text, instructions, hints, or dialogue content that is provided to the user through the artificial intelligence device.

The term “in-game event” refers to an event that occurs within a game or interactive content environment, including actions, scene changes, character behaviors, or progression-related triggers that are influenced by the user's interaction with the artificial intelligence device and the responses generated by the generative AI model.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

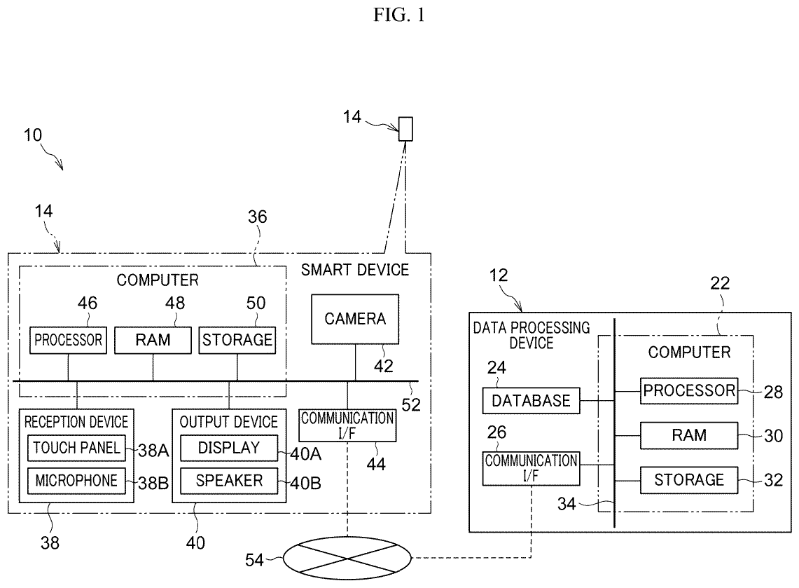

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

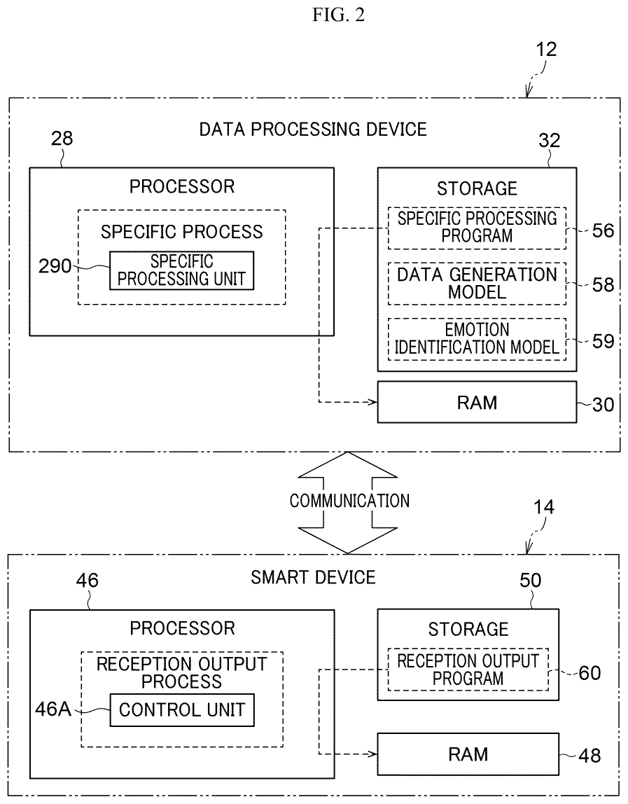

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional interactive game systems that incorporate location-based events and conversational artificial intelligence often treat game logic, user context management, and natural language generation as loosely coupled components. In many implementations, a game server merely forwards user questions and raw position data to a generic conversational service, and the conversational service generates responses without deep integration with the user's precise location, detailed game state, or event history. As a result, the generated hints and dialogue are frequently inconsistent with the actual progress of the user, redundant with previously provided information, or overly generic, which degrades the user experience and increases unnecessary network traffic and processing load due to repeated, context-poor calls to an external model.

Further, in typical architectures, the server does not systematically structure input to a generative AI model as a well-defined prompt sentence that captures hierarchical context such as system role, area information, user progress status, and dialogue history. Instead, ad-hoc concatenation of text is used, which makes it difficult to guarantee predictable behavior of the generative AI model, to optimize resource utilization, or to ensure that responses are aligned with game design constraints. This lack of a standardized, machine-enforced prompt structure leads to inefficiencies in processing, difficulty in scaling to large numbers of concurrent users, and increased engineering effort to maintain and evolve the system.

Additionally, conventional systems often fail to leverage event occurrence history and response history as first-class state information. Consequently, when a user repeatedly visits the same location or re-triggers the same event, the system tends to provide identical or nearly identical hints. This not only diminishes the perceived intelligence of the system but also wastes computation on generating unhelpful, redundant outputs. From a computer technology perspective, such designs do not exploit server-side state management to reduce repeated processing, nor do they optimize how and when calls to a generative AI model are made.

Accordingly, there is a need for an improved computer-implemented system and processing method that: (i) systematically acquires and manages user authentication information, location information, game state information, and dialogue history on a server; (ii) constructs structured, hierarchical prompt sentences that encode this state for efficient and controlled interaction with a generative AI model; and (iii) dynamically varies generated hints and dialogue based on accumulated event and response histories. Such a system should improve the technical functioning of the server-side processing workflow by reducing redundant calls to the generative AI model, ensuring context-appropriate responses, and enabling scalable, state-aware dialogue and hint generation for location-based interactive applications.

The specific processing by the specific processing unit 290 of the data processing device 12 in Example 1 is realized by the following means.

The present invention provides a server comprising a processor and a storage device, the processor being configured to execute computer-readable instructions that cause the server to: receive user identification information from an information processing terminal, compare the user identification information with authentication information stored in the storage device, and determine usage authorization for a user; receive location information of the user acquired by a location information acquisition unit of the information processing terminal, refer to a plurality of area information items stored in the storage device, determine whether the user has reached a predetermined area based on the location information and the plurality of area information items, and, when it is determined that the user has reached the predetermined area, cause a corresponding game event to occur; acquire game state information stored in the storage device and the location information when the game event occurs, construct, based on the game state information and the location information, a structured prompt sentence as hierarchical text data including role information defining a role of the server, area information corresponding to a current position of the user, progress information corresponding to an achievement status of the user, and question content or hint context, transmit the prompt sentence to a generative artificial intelligence model executed on one or more computing resources, and obtain from the generative artificial intelligence model a response including hint information; record, in association with the game state information and the location information, a natural language question input by the user and a past dialogue history, generate a further prompt sentence to be input to the generative artificial intelligence model based on the question, the past dialogue history, the game state information, and the location information, and transmit a response obtained from the generative artificial intelligence model based on the further prompt sentence to the information processing terminal; and store, as part of the game state information in the storage device, an occurrence history of game events and a response history generated by the generative artificial intelligence model, and, based on the occurrence history and the response history, generate different prompt sentences when the user reaches a same predetermined area a plurality of times so that stepwise different hint information is provided. This enables improved computer-implemented control of interactions with the generative artificial intelligence model by enforcing a server-side, state-aware prompt construction process that reduces redundant processing, tailors responses to user location and progress, and dynamically varies generated hints and dialogue, thereby enhancing system efficiency, scalability, and the technical quality of context-dependent natural language outputs.

The term “user identification information” refers to data that identifies a particular user of the system, including at least a user identifier and optionally a password or other authentication credential supplied from an information processing terminal.

The term “authentication information” refers to reference data stored in a storage device for verifying the identity of a user, such as a stored user identifier, a stored password hash, or other verification data used for determining usage authorization.

The term “usage authorization” refers to a determination made by the processor as to whether a user is permitted to access or use at least part of the functions or data of the system based on a comparison between user identification information and authentication information.

The term “information processing terminal” refers to an electronic apparatus used by a user to interact with the system, including at least a computing unit, an input unit, a display unit, and a communication unit, such as a portable terminal, a stationary terminal, or other general-purpose computing device.

The term “location information acquisition unit” refers to a hardware and software combination included in or associated with an information processing terminal that acquires information indicative of a physical or virtual position of the terminal, such as a positioning sensor, a positioning module, or a software interface to such components.

The term “location information” refers to data representing a position associated with a user or an information processing terminal, such as coordinates, region identifiers, or other position-indicating values obtained by a location information acquisition unit.

The term “storage device” refers to one or more physical recording media and associated control circuitry capable of storing data and programs, such as a semiconductor memory, a magnetic storage apparatus, or an optical storage apparatus.

The term “area information” refers to data defining one or more predetermined areas used by the system, such data including at least position information, shape information, and optionally a radius or boundary condition for determining whether a user has reached a predetermined area.

The term “predetermined area” refers to a spatial region specified in advance in the area information and used as a condition for determining occurrence of a game event or other processing.

The term “game event” refers to a processing operation or state transition in a game scenario that is executed or caused by the system when one or more conditions, including at least a user reaching a predetermined area, are satisfied.

The term “game state information” refers to data indicative of a current or past state of a game in relation to a user, including at least progress information, event occurrence history, and optionally inventory information, visited locations, or other state variables managed by the system.

The term “progress status” refers to information representing a degree of completion of one or more tasks, quests, or objectives in a game by a user, derived from or included in game state information.

The term “guidance information” refers to information generated by the processor that indicates a next target point, a next game event, or other recommended actions for a user to continue or advance within a game.

The term “generative artificial intelligence model” refers to a computational model, such as a machine learning model or a neural network model, configured to generate natural language or other content in response to input data, including at least a prompt sentence.

The term “prompt sentence” refers to structured text data, including at least one or more elements such as role information, area information, progress information, and user input content, that is provided as input to a generative artificial intelligence model to control or influence content of a generated response.

The term “role information” refers to data included in a prompt sentence that defines or constrains a behavior or viewpoint of the generative artificial intelligence model, such as a description of an agent role, a system role, or a character role.

The term “hierarchical text data” refers to text data organized in a nested or layered structure, in which different categories of information, such as role information, area information, progress information, and user input content, are distinguishable and can be individually identified or processed.

The term “natural language question” refers to a question expressed by a user in a human language, such as written or spoken text, that is input to the system and treated as user input content.

The term “dialogue history” refers to a sequence of past exchanges between a user and the system, including at least previous user inputs and previous responses output by or via a generative artificial intelligence model, which is stored and referenced as context information.

The term “response including hint information” refers to output data generated by a generative artificial intelligence model that contains at least guidance or advice relevant to a user's progression, position, or objective in a game or application context.

The term “occurrence history of game events” refers to data indicating which game events have been caused for a user, including at least identifiers of the events, times of occurrence, and optionally associated conditions.

The term “response history” refers to stored information about responses generated by a generative artificial intelligence model and provided to a user, including at least response contents and associated context such as time, location, or related game events.

The term “artificial intelligence apparatus” refers to a logical or physical component that utilizes a generative artificial intelligence model, directly or via a server, to conduct interactions with a user, including at least presentation of responses and reception of user inputs.

The term “different prompt sentences” refers to multiple prompt sentences that are not identical to one another, in which at least one element, such as area information, progress information, dialogue history, or generated hint context, is varied based on game state information.

The term “stepwise different hint information” refers to plural pieces of hint information that differ from each other in content or level of detail and are provided to a user in a staged manner as the user's game state or interaction history evolves.

In one embodiment, a server cooperates with at least one terminal operated by a user to implement a location-based interactive game that uses a generative AI model. The server includes a processor, a storage device, a communication interface, and optionally a hardware cryptographic module. The terminal includes a processor, a memory, a display unit, an input unit, a communication interface, and a location information acquisition unit such as a GPS module or a positioning sensor exposed through an operating system API.

The server executes a program stored in the storage device. The program is implemented, for example, using a web application framework such as a generic server-side runtime, an HTTP server, and a relational database management system such as a general-purpose database engine. The server program is stored as machine-executable instructions that cause the processor to implement user authentication, stateful game control, spatial determination of user position relative to predefined areas, construction of structured prompt sentences, and interaction with a generative AI model.

The terminal executes an application program stored in its memory. The application program is implemented, for example, as a native application executable on a general-purpose mobile operating system, and uses a user interface framework provided by the operating system. The terminal program causes the terminal processor to display a game field, to request and display hints and guidance, to capture user inputs such as login credentials, gestures, and natural language questions, and to acquire and transmit location information obtained from the location information acquisition unit.

The server stores, in the storage device, a plurality of data structures including at least: a user table, an authentication information table, a game state table, an area definition table, an event definition table, and a dialogue history table. The user table stores user identifiers. The authentication information table stores hashed passwords and optional multi-factor tokens. The game state table stores, for each user identifier, progress status, a list of completed events, a list of discovered areas, and identifiers of active quests. The area definition table stores identifiers of predetermined areas, geometric definitions such as latitude and longitude coordinates and radius or polygon vertex sets, and associated event identifiers. The event definition table stores, for each event identifier, trigger conditions, narrative descriptions, and default guidance texts. The dialogue history table stores sequences of user utterances and associated model responses, with timestamps and references to quests and areas.

The server stores program code that, when executed by the processor, causes the server to receive user identification information from the terminal over a secure communication channel such as HTTPS. The server performs authentication by comparing received credentials with data in the authentication information table using a cryptographic library that implements a password hashing function such as a key-derivation function. By performing authentication at the server and issuing a session token that encapsulates user identity and expiration time, the server establishes a secure context for subsequent processing.

The terminal acquires location information by accessing the location information acquisition unit through an operating system API such as a generic location service. The terminal converts raw sensor data into normalized coordinates and accuracy values and transmits these as structured data to the server at defined intervals or when movement exceeds a distance threshold. The server receives the location information and references the area definition table using a spatial calculation routine. In one embodiment, the server uses a spatial extension of the database to perform geometric operations such as point-in-polygon tests or distance comparisons between the user position and stored area geometries. By performing these calculations in the database engine using optimized spatial indices, the server reduces CPU load in the application layer and accelerates determination of whether the user has reached a predetermined area.

The server, upon determining that the user has reached a predetermined area and that corresponding trigger conditions specified in the event definition table are satisfied, updates the game state table to record occurrence of a game event. The server thereby maintains a consistent event occurrence history for each user. At this time, the server retrieves relevant game state information, including current progress status, list of previously triggered events, and accumulated dialogue history, and constructs a prompt sentence to be supplied to a generative AI model.

The generative AI model is implemented, in one embodiment, as a transformer-based neural network. The server may interact with the model via a separate AI backend service that executes on computing hardware such as a general-purpose processor combined with a graphics processing unit. The transformer architecture includes an input embedding layer, a plurality of self-attention layers, feed-forward layers, normalization layers, and an output projection layer. The model is pre-trained on large-scale text data and optionally fine-tuned on domain-specific dialogue data such as game scripts and hint examples. During fine-tuning, the model parameters are optimized by minimizing a loss function such as cross-entropy between predicted tokens and reference tokens, using a gradient-based optimization algorithm such as stochastic gradient descent or an adaptive optimizer. The model uses multi-head attention to capture relationships between tokens within the prompt sentence and computes contextualized representations for each token.

The server constructs the prompt sentence as hierarchical text data. In one example, the server concatenates multiple segments with explicit labels or markers, such as:

“System: You are a helpful in-game guide in a location-based fantasy adventure. Provide a short, friendly hint.

Context:
Current area: ancient ruins plaza.
Current quest: Find the North Tower.
Target location: a tower at the northern edge of the ruins, marked by a red flag.

Constraints: Avoid revealing exact coordinates or full solutions.

Instruction: Give a concise hint in one or two sentences.”

In another example where the user asks a direct question, the server constructs a prompt sentence such as:

“System: You are an in-game guide character in a fantasy ruins exploration game. You must answer briefly, immersive and helpful, without revealing major spoilers.

Context:
The user is at the central plaza of the ruins.
The user has not yet found the North Tower.
The North Tower is at the northern edge of the ruins and is marked by a red flag.

Conversation so far:

[previous exchanges may be inserted here]

User: Where is the North Tower?

Assistant: Respond as the guide character.”

The server, by explicitly encoding role information (“System: You are a helpful in-game guide”), area information (“Current area: ancient ruins plaza”), progress status (“The user has not yet found the North Tower”), and conversation context (“Conversation so far”), creates a structured prompt sentence that the generative AI model can interpret consistently. This differs from conventional ad hoc string concatenation, because the server uses fixed labels and a predefined layout for each segment of the prompt sentence. As a result, the generative AI model can more reliably attend to relevant parts of the input, which improves the technical quality of model outputs and reduces the likelihood of inconsistent or context-mismatched responses.

The server executes a prompt-construction algorithm that maps internal state variables to segments of the prompt sentence. This algorithm uses explicit selection rules and fallbacks. For example, the server selects a role template based on the current game mode, inserts area names and quest names retrieved from the area definition table and the game state table, and truncates dialogue history to a maximum number of turns or characters to maintain inference speed while preserving essential context. By constraining the size and structure of the prompt sentence, the server reduces the computational load on the generative AI model, leading to lower latency and more predictable memory usage during inference.

The terminal sends user questions to the server as natural language text obtained from a text input field or a speech-to-text engine. The server records each user question as an entry in the dialogue history table together with a timestamp, a reference to the current event, and the user's location. The server then generates a context-aware prompt sentence based on this question and the recorded history and sends it to the generative AI model for inference. The generative AI model processes the prompt sentence token by token, computing attention weights between tokens and generating probability distributions over candidate tokens at each position in the output. The model selects tokens using a decoding method such as greedy decoding or sampling with temperature control to balance determinism and variation.

The server receives the raw token sequence output by the generative AI model and decodes it into character strings. The server applies post-processing steps including removal of undesirable patterns, enforcement of maximum length, and, if necessary, substitution of forbidden terms with safe alternatives. The server then updates the dialogue history table with the generated response and transmits the processed text to the terminal. The terminal displays the generated text as a dialogue bubble associated with a visual representation of an artificial intelligence apparatus, such as a character icon or avatar.

The server uses the game state table and the dialogue history table to determine whether to vary hints when the user re-enters the same predetermined area. For example, if the user has already received a basic directional hint for the “North Tower” event, the server selects a second-level hint template that provides more specific but still non-spoiling information. The server constructs a second-level prompt sentence indicating that an initial hint has already been delivered and specifying that the generative AI model should provide a new hint that builds upon the previous one, such as:

“System: You previously told the user to look toward the northern edge of the ruins. The user is still unable to find the North Tower. Provide a slightly more detailed hint, but do not reveal the exact location or story spoilers.”

By encoding such stepwise instructions, the server ensures that repeated calls to the generative AI model yield varied, progression-aware hints, which improve user guidance and avoid unnecessary repetition. This stepwise hint generation also reduces user confusion and shortens the time needed to complete objectives, which in turn reduces the number of model inferences required, improving computational efficiency.

The server can implement alternative embodiments for the generative AI model. In one variant, the server uses a locally hosted model that runs within the same data center, controlled via an internal API. In another variant, the server accesses a remote AI service over a network. The model may be a decoder-only transformer, an encoder-decoder transformer, or another neural sequence model, as long as the input prompt sentence and output text can be processed according to the described architecture. The training process can use additional techniques such as curriculum learning, teacher forcing, scheduled sampling, or data augmentation to improve robustness in handling the structured prompts defined by the server.

The server improves computer technology in multiple respects. By encoding state as structured prompt sentences and mapping complex, multi-source context (location, progress, dialogue history) into a consistent textual format, the server enables the generative AI model to generate higher-quality responses with fewer tokens and fewer inference calls than would be required by a naive implementation. Because the prompt-construction algorithm uses deterministic rules and bounded prompt size, the server can predict and control memory consumption and latency of model inference more accurately, thereby improving scalability when many users are connected concurrently. Additionally, because the server maintains a detailed event occurrence history and response history, it can decide when to reuse cached responses or when to generate new ones, which further reduces computational overhead and network traffic.

The terminal benefits from reduced data volume and simplified logic. Rather than performing heavy natural language processing locally, the terminal transmits compact state descriptors such as location coordinates and user questions. The server performs state integration and prompt construction centrally, which simplifies terminal implementation and reduces energy consumption on mobile devices. The system thereby achieves a technical effect of distributing computation according to hardware capabilities: the server performs complex model inference and stateful computations, and the terminal performs rendering and sensor acquisition.

The system also improves accuracy and consistency in spatial event triggering. Because the server uses spatial indices and geometry functions on the area definition table, the system can handle many predetermined areas efficiently and robustly. The use of server-side spatial calculations avoids inconsistent behavior that may arise when each terminal independently approximates distance checks with varying precision or coordinate systems. The centralization of these calculations in a single optimized server process improves determinism and lowers the risk of errors, such as missed or duplicate event triggers.

The system uses specific non-conventional processing rules that differ from manual human operations. For example, the server determines, by explicit logic, which parts of the dialogue history are relevant and automatically prunes or summarizes older messages to maintain a context window suitable for the generative AI model. A human game master would typically not manage such context windows in a token-based manner. The server also follows explicit rules to map game-state flags and area identifiers into text descriptions that are consistent across all prompts, ensuring that the model's input distribution matches the patterns it was fine-tuned on. This approach is tailored to the internal representation and training data of the generative AI model and thus constitutes an improvement in how computers integrate structured state data with neural-network inference.

In another embodiment, the server supports different game modes and content types by changing the role information and templates used for prompt sentence construction. For example, the server can switch from a “guide” role to an “adversary” role for certain events by changing the initial role segment in the prompt sentence:

“System: You are a mysterious adversary who provides cryptic hints rather than direct guidance.”

The underlying prompt-construction engine remains the same, but the content segment changes in a controlled manner. The server can also use metadata in the event definition table to select tone parameters (e.g., “formal”, “humorous”) and enforce them in the role segment. This flexible, rule-driven mapping from structured data to prompt sentences allows the system to support varied application contexts without changing the underlying model weights, which is a form of configuration-layer adaptability that improves the reusability and maintainability of the system.

In yet another embodiment, the server implements caching and deduplication mechanisms for prompt sentences and corresponding model outputs. When the server detects that two users share identical or nearly identical context, such as the same area, same progress status, and same question, the server may reuse a previously generated response instead of invoking the generative AI model again. To enable this, the server computes a hash or canonical representation of the structured prompt sentence, uses it as a key in a cache table, and retrieves stored responses if available. This reduces inference load on the AI backend, improves response times, and lowers operational costs, which are technical advantages in distributed computation and networked systems.

The described embodiments can be combined or modified. For example, the server may use a first model for coarse classification of user intent and a second model for detailed response generation. The server may also adjust the amount of dialogue history included in the prompt sentence based on measured latency or available compute capacity, thus dynamically trading off context richness against performance. These variations remain within the scope of the inventive concept because they preserve the core mechanisms of centralized, state-aware prompt construction and use of a generative AI model for contextually appropriate, location-and progress-dependent responses.

By orchestrating the described hardware components, data structures, and software procedures, the server, terminal, and user cooperate to provide an interactive environment where hints and dialogue are generated using a generative AI model in a technically efficient and state-aware manner. The system goes beyond simple automation of human tasks by introducing machine-optimized prompt sentence structures, server-side spatial and stateful logic, and model-targeted context encoding, thereby improving processing efficiency, output quality, and scalability of computer-implemented interactive applications.

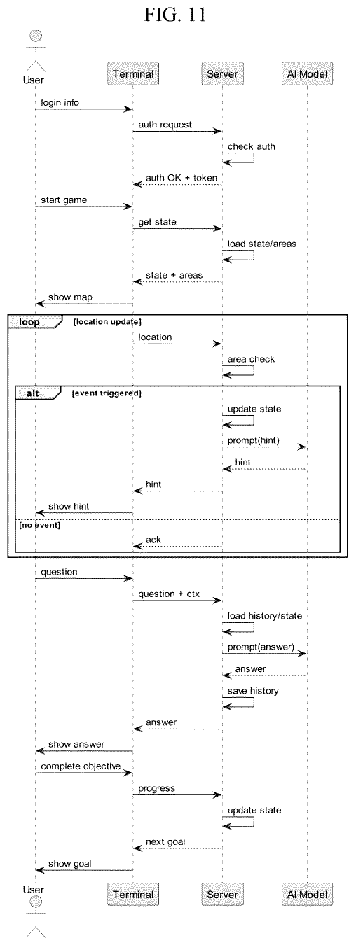

The following describes the processing flow using FIG. 11.

### Step 1

Server receives user identification information and performs authentication.

Server takes as input a user identifier and an authentication credential (for example, a password) transmitted from the terminal.

Server accesses a storage device to retrieve corresponding authentication information, such as a stored password hash and account status.

Server performs data processing by applying a cryptographic hash function to the received password and comparing the result with the stored password hash.

Server determines whether the user is authorized, generates either an authentication success result or an error code, and outputs an authentication response including, in case of success, a session token to the terminal.

### Step 2

Terminal sends a request for initial game state after successful authentication.

Terminal takes as input the session token obtained from the server and a user action indicating that the game should start.

Terminal packages the session token into a request message and outputs an initial-state request to the server through a communication interface.

### Step 3

Server provides initial game state and area definitions.

Server takes as input the initial-state request including the session token from the terminal.

Server validates the session token, then accesses a game state table to retrieve the user's progress status, completed events, and active quests, and accesses an area definition table to retrieve definitions of predetermined areas and associated event identifiers.

Server performs data processing by assembling these records into a structured data object that represents the current game state and relevant area information.

Server outputs a response containing the initial game state and area definitions to the terminal.

### Step 4

Terminal initializes the game display and internal state.

Terminal takes as input the game state and area definitions from the server.

Terminal performs data processing by mapping area coordinates to a screen coordinate system, generating display objects for markers, and storing the user's current objective and relevant area identifiers in local memory.

Terminal outputs a rendered game field on the display, showing the current objective and any visible markers corresponding to important areas.

### Step 5

Terminal acquires location information of the user.

Terminal takes as input raw sensor readings from a location information acquisition unit, such as GPS measurements and associated timestamps.

Terminal performs data processing by converting the sensor readings into normalized location information including latitude, longitude, accuracy, and time, and by optionally filtering noise using a simple smoothing or thresholding algorithm.

Terminal outputs normalized location information and transmits it to the server together with the session token.

### Step 6

Server determines whether the user has reached a predetermined area.

Server takes as input the normalized location information and the session token from the terminal.

Server validates the session token, then accesses the area definition table to obtain geometric data for predetermined areas and, if available, uses spatial index structures to pre-select nearby areas.

Server performs data processing by executing spatial calculations, such as computing a distance between the user's position and area centers or evaluating point-in-polygon relationships using geometry functions.

Server compares the computed distances or inclusion results with thresholds or boundary definitions to determine whether the user has reached a predetermined area, and outputs a result indicating either no event trigger or an event trigger for a specific area.

### Step 7

Server triggers a game event and updates game state.

Server takes as input the determination that the user has reached a predetermined area, along with the corresponding area identifier and existing game state information for the user.

Server evaluates event trigger conditions in an event definition table, including checks on prerequisite events and current progress status.

Server performs data processing by updating the game state table to record an occurrence history entry for the triggered event, including event identifier, timestamp, and user identifier.

Server outputs an event notification including the event identifier and basic event parameters to the terminal.

### Step 8

Terminal presents an artificial intelligence apparatus in response to the triggered event.

Terminal takes as input the event notification from the server.

Terminal performs data processing by matching the event identifier to local configuration that defines how an artificial intelligence apparatus should be displayed, such as a character avatar, dialogue window, or animation.

Terminal outputs a visual representation of the artificial intelligence apparatus on the display, indicating to the user that an AI-assisted hint or dialogue is available.

### Step 9

Server constructs a prompt sentence for a generative AI model to generate a hint.

Server takes as input the event identifier, the user's current location information, and game state information including progress status and past hints.

Server retrieves related narrative descriptions, target location descriptions, and any previously delivered hints from the storage device.

Server performs data processing by selecting a role template, inserting current area names and quest names, encoding constraints such as “do not reveal full solution,” and organizing these elements into a hierarchical text structure.

Server constructs a prompt sentence, for example:

“System: You are a helpful in-game guide in a location-based fantasy adventure. Provide a short, friendly hint.

Context:
Current area: ancient ruins plaza.
Current quest: Find the North Tower.
Target location: a tower at the northern edge of the ruins, marked by a red flag.

Constraints: Avoid revealing exact coordinates or full solutions.

Instruction: Give a concise hint in one or two sentences.”

Server outputs the constructed prompt sentence as input data to the generative AI model.

### Step 10

Generative AI model generates a hint response based on the prompt sentence.

Server takes as input the prompt sentence and forwards it to the generative AI model executed on one or more computing resources.

The generative AI model performs internal data processing by converting the prompt sentence into token embeddings, applying multiple layers of self-attention and feed-forward transformations, computing probability distributions over output tokens, and decoding these probabilities into a sequence of natural language tokens.

Server receives the generated token sequence from the generative AI model, decodes it into a text string representing a hint, and outputs the hint text as a response associated with the event.

### Step 11

Server post-processes the generated hint and sends it to the terminal.

Server takes as input the raw hint text produced by the generative AI model and the user's contextual information.

Server performs data processing by truncating the text to a maximum length, filtering inappropriate words, and optionally inserting line breaks or formatting markers suitable for display on the terminal.

Server updates the dialogue history table with the prompt sentence and the generated hint text, then outputs a hint message containing the final text to the terminal.

### Step 12

Terminal displays the hint to the user.

Terminal takes as input the hint message from the server.

Terminal performs data processing by associating the hint text with the visual representation of the artificial intelligence apparatus and by selecting fonts, sizes, and layout based on user interface settings.

Terminal outputs the hint text on the display, for example as a dialogue bubble above the AI character, so that the user can read the hint.

### Step 13

User inputs a natural language question to the artificial intelligence apparatus.

User takes as input the displayed hint and the current situation in the game field and decides to ask a follow-up question.

User operates the input unit of the terminal to type or dictate a natural language question, such as “Where is the North Tower?”

User outputs the question to the terminal, which receives the input for further processing.

### Step 14

Terminal transmits the user's question and context to the server.

Terminal takes as input the natural language question, the session token, the user's current location information, and identifiers of the active event and quest.

Terminal performs data processing by assembling these elements into a structured message, including fields for question text, location, progress status, and event identifier.

Terminal outputs the structured message as a dialogue request sent to the server via the communication interface.

### Step 15

Server records dialogue history and constructs a context-rich prompt sentence.

Server takes as input the dialogue request from the terminal, including the question text and context.

Server accesses the dialogue history table to retrieve previous exchanges related to the same quest or event and accesses the game state table to confirm the current progress status.

Server performs data processing by organizing the retrieved history, the new question, role information, area information, and progress information into a new prompt sentence, for example:

“System: You are an in-game guide character in a fantasy ruins exploration game. You must answer briefly, immersive and helpful, without revealing major spoilers.

Context:
The user is at the central plaza of the ruins.
The user has not yet found the North Tower.
The North Tower is at the northern edge of the ruins and is marked by a red flag.

Conversation so far:

[previous user and assistant messages]

User: Where is the North Tower?

Assistant: Respond as the guide character.”

Server writes the user's question to the dialogue history table and outputs the constructed prompt sentence to the generative AI model as input.

### Step 16

Generative AI model generates a dialogue response.

Server takes as input the context-rich prompt sentence.

The generative AI model performs internal data processing by encoding the prompt sentence, computing attention-based contextual representations, generating a distribution over possible next tokens at each step, and selecting tokens according to a decoding strategy such as greedy decoding or probabilistic sampling.

Server receives the output token sequence, decodes it into a natural language response such as “The North Tower stands at the far northern boundary of these ruins. If you follow the paths leading north and watch for a red flag above the stones, you will find it,” and outputs this response for post-processing.

### Step 17

Server stores the response and sends it to the terminal.

Server takes as input the generated response text and the current dialogue context.

Server performs data processing by appending the response text to the dialogue history table, associating it with the corresponding question, event, and timestamp, and optionally tagging the response with metadata such as response length and sentiment.

Server outputs a dialogue response message containing the processed text and any display parameters to the terminal.

### Step 18

Terminal displays the AI-generated response.

Terminal takes as input the dialogue response message from the server.

Terminal performs data processing by updating the dialogue window or message list, positioning the new response in sequence with previous messages, and possibly scrolling the view to ensure the newest message is visible.

Terminal outputs the AI-generated text to the display as part of the conversation with the artificial intelligence apparatus, making the response available for the user to read.

### Step 19

Server updates game progress and generates guidance based on user actions.

Server takes as input subsequent user actions transmitted by the terminal, such as confirmation that the user has reached a target area or completed an objective.

Server accesses the game state table, updates the progress status, marks relevant events as completed, and evaluates rules to determine the next objective or event.

Server performs data processing by constructing guidance information, including a description of the next target point and optional coordinates or relative directions, and by deciding whether another hint event should be scheduled.

Server outputs updated game state and guidance information to the terminal.

### Step 20

Terminal presents updated guidance to the user.

Terminal takes as input the guidance information from the server.

Terminal performs data processing by updating on-screen markers, objectives, and informational messages according to the new guidance, including recalculating paths or highlighting new areas on the map.

Terminal outputs the updated visual guidance on the display so that the user can continue exploration and interaction with the generative AI model in a context-aware manner.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional interactive guidance systems deployed in physical environments, such as retail facilities or entertainment venues, often rely on static rule-based logic or simple keyword matching to provide information to users. These systems typically separate location determination, event triggering, and answer generation into loosely coupled subsystems with limited context sharing. As a result, several technical problems arise in terms of computer technology.

First, when a user moves within a complex indoor environment, a server that merely receives raw position information and triggers fixed events cannot efficiently correlate the user's current position, past movement history, and dialog history. This leads to inefficient use of processing resources, because the server repeatedly performs redundant determination and content selection without leveraging accumulated contextual data. It also leads to inconsistent responses, since the system cannot adapt prompt construction or event selection to the user's prior interactions.

Second, in existing architectures that use a generative AI model, the server typically forwards user questions directly to the model with minimal pre-processing. This naive usage creates several technical drawbacks: (i) the generative model operates on underspecified prompts that lack structured context such as region information, game state information, or product arrangement information, resulting in low-quality or ambiguous responses; (ii) the server must perform expensive post-hoc corrections to align the generated responses with actual database records, increasing processing load and latency; and (iii) conversation history, event history, and location history are not systematically reused to optimize subsequent prompt sentences, leading to unnecessary repeated calls to the generative model and inefficient use of network and computation resources.

Third, many systems that attempt to gamify guidance experiences implement the “game layer” on the client side, while the server only performs simple data retrieval. In such systems, the server does not centrally manage game progress, game events, and reward control in conjunction with the generative AI model's outputs. Consequently, the server cannot compute coherent, state-dependent prompts and responses that reflect both the physical position of the user and the evolving game state, which limits the ability to optimize server-side processing flows and to reduce inconsistencies between game behavior and AI responses.

Accordingly, there is a need for a technical framework in which a server-side processor: (i) integrates position determination, event triggering, and dialog management; (ii) dynamically generates prompt sentences for a generative AI model based on structured context including user position, region information, game state information, and product arrangement information; and (iii) maintains and utilizes history information comprising position information, question information, generated prompt sentences, and user-oriented response sentences to improve subsequent processing. By reorganizing the server's functional configuration and data flows in this way, the underlying computer technology can be improved in terms of processing efficiency, consistency of responses, reduction of redundant computations, and quality of AI-assisted guidance in a location-based, game-like interaction environment.

The specific processing by the specific processing unit 290 of the data processing device 12 in Application Example 1 is realized by the following means.

The present invention provides a server comprising a processor configured to acquire position information of a user from a location acquisition device of a portable information terminal carried by the user, to compare the acquired position information with a plurality of region information items stored in a region information storage unit by using a position determination function, to determine whether the user has reached a predetermined region, and to generate control information including event information in accordance with a result of the determination; to transmit, on the basis of the control information, output instruction information including guidance information or game hint information to be presented to the user to an artificial intelligence device having at least one of a sound output device and a display device, via a communication function, and to control an information presentation operation of the artificial intelligence device; to generate, on the basis of question information including a question sentence received from the portable information terminal, and context information including the position information of the user and the event information, a prompt sentence to be input to a generative natural language processing model, by using a prompt generation function; to transmit the prompt sentence to an external generative natural language processing model, to acquire response information including a response sentence generated by the generative natural language processing model, to perform predetermined content verification processing and correction processing on the response sentence, and to generate a user-oriented response sentence by using a response generation function; to transmit the user-oriented response sentence to the portable information terminal via the communication function, and also to transmit the user-oriented response sentence to the artificial intelligence device, and to control display on the portable information terminal and output by the artificial intelligence device; and to store the position information, the question information, the prompt sentence, and the user-oriented response sentence as history information in a storage unit, and to perform update control of generation of a subsequent prompt sentence or selection of subsequent event information on the basis of the history information. This enables the server to integrate position-based event triggering and dialog control in a unified processing flow, to supply the generative natural language processing model with dynamically constructed, context-rich prompt sentences that reflect region information, game state information, and product arrangement information, and to iteratively refine subsequent prompt generation and event selection using accumulated history information, thereby improving computational efficiency, response consistency, and overall performance of location-based interactive guidance in a computer-implemented system.

The term “processor” refers to a hardware-based or virtualized computation unit, such as a central processing unit, microcontroller, or processing core in a server or information processing apparatus, that executes machine-readable instructions to perform the functions described herein.

The term “portable information terminal” refers to a user-carried electronic device having at least a communication function, a user interface, and a location acquisition function, such as a handheld terminal, mobile communication device, or other portable computing device capable of sending and receiving data over a network.

The term “location acquisition device” refers to a hardware and software combination included in or coupled to the portable information terminal that is configured to obtain position information of the terminal, such as a positioning sensor, a wireless signal-based position detector, or an equivalent position detection component.

The term “position information” refers to data representing a physical or logical location of the user or the portable information terminal, including but not limited to geographic coordinates, indoor region identifiers, floor information, or zone identifiers within a facility.

The term “region information” refers to data defining one or more predetermined areas or zones in a physical space, including boundaries, identifiers, and attributes associated with those areas, which are used to determine whether the user has reached a corresponding region.

The term “region information storage unit” refers to a logical or physical storage resource, such as a memory or database, that stores region information for use by the processor in position determination and event triggering.

The term “position determination function” refers to processing logic executed by the processor to compare position information with region information and to determine whether the user is located in, or has entered, a predetermined region.

The term “event information” refers to data indicating an occurrence or condition to be triggered when certain criteria are met, such as the user reaching a particular region, including identifiers, types, and parameters of events to be executed.

The term “control information” refers to data generated by the processor that specifies how subsequent processing should be performed in response to a determination or event, including event information and parameters for controlling information presentation or system behavior.

The term “artificial intelligence device” refers to an information presentation apparatus, which may include computing resources and input/output components, that is configured to interact with a user by outputting information and optionally receiving inputs, under control of the server.

The term “sound output device” refers to a hardware component, such as a speaker or audio transducer, that outputs audio signals to the user in accordance with control signals generated by the processor or artificial intelligence device.

The term “display device” refers to a hardware component, such as a screen, monitor, or other visual output interface, that visually presents characters, images, or graphical elements to the user.

The term “communication function” refers to hardware and software resources that enable data exchange between system components, such as network interfaces, communication protocols, and related control logic used to send and receive messages.

The term “output instruction information” refers to data transmitted from the processor to the artificial intelligence device that specifies information to be presented to the user and parameters for the presentation, such as timing, modality, and format.

The term “guidance information” refers to information that assists the user in navigating a physical environment or locating an object or service, including directions, location descriptions, and operation instructions.

The term “game hint information” refers to information related to a game-like scenario or mission, including clues, suggestions, or partial answers that assist the user in progressing in a game or interactive experience.

The term “question information” refers to data received from the portable information terminal that includes a user-generated inquiry, typically expressed as a natural language question sentence, optionally along with associated metadata.

The term “question sentence” refers to a text string or equivalent representation in natural language that expresses a user's inquiry or request for information, which is subject to processing by the generative model.

The term “context information” refers to data that supplements question information, including position information, event information, region information, game state information, and product-related information, which is used to construct context-aware prompt sentences.

The term “prompt sentence” refers to a text string or structured input generated by the processor and supplied to a generative natural language processing model, the text string defining model role, constraints, policies, and context for generating an appropriate response.

The term “prompt generation function” refers to processing logic executed by the processor to assemble question information and context information into a prompt sentence that is suitable for input to a generative natural language processing model.

The term “generative natural language processing model” refers to a trained computational model, implemented in software and executed on computing hardware, that generates natural language output based on an input prompt by using machine learning or statistical methods.

The term “response information” refers to data output by the generative natural language processing model that includes a response sentence or other generated content corresponding to the input prompt sentence.

The term “response sentence” refers to a natural language text string generated by the generative natural language processing model as an answer or reaction to the prompt sentence.

The term “content verification processing” refers to processing performed by the processor to check a generated response sentence against internal rules, databases, or constraints, in order to validate correctness, compliance, or relevance.

The term “correction processing” refers to processing performed by the processor to modify, supplement, or normalize a generated response sentence, for example by correcting errors, aligning with internal data, or adjusting format.

The term “user-oriented response sentence” refers to a response sentence that has been verified and corrected by the processor and that is formatted and adapted for presentation to the user via the portable information terminal and/or the artificial intelligence device.

The term “response generation function” refers to processing logic executed by the processor to receive response information from the generative natural language processing model, perform content verification and correction, and produce a user-oriented response sentence.

The term “storage unit” refers to any hardware or virtual storage resource, such as memory or a database system, configured to store various types of information including history information for later use by the processor.

The term “history information” refers to accumulated data including position information, question information, prompt sentences, and user-oriented response sentences associated with past interactions, which is stored for subsequent analysis and control.

The term “update control” refers to processing by which the processor modifies conditions, parameters, or data used in subsequent processing, such as prompt sentence generation or event selection, in accordance with stored history information.

The term “event selection” refers to processing by which the processor chooses one or more events or pieces of event information to trigger or present, based on current and past data including history information.

The term “product arrangement information” refers to data stored in a product information storage unit that describes locations, categories, and attributes of items or resources in a physical environment.

The term “product information storage unit” refers to a storage resource, such as a database, that holds product arrangement information and related data used to support guidance and answer generation.

The term “role” refers to an instruction element included in a prompt sentence that defines the behavior, perspective, or function the generative natural language processing model should adopt when generating a response.

The term “constraint conditions” refers to instruction elements included in a prompt sentence that specify limitations, prohibitions, or required properties applicable to responses generated by the generative natural language processing model.

The term “answer policy” refers to instruction elements included in a prompt sentence that define style, level of detail, content focus, or other guidelines the generative natural language processing model should follow when generating a response.

The term “game state information” refers to data indicating a current progress state or status of a game or interactive scenario, including completed events, current missions, and reward statuses.

The term “game progress information” refers to information representing a temporal or logical progression of game activities, including milestones, levels, or stages that a user has reached.

The term “game state management function” refers to processing logic executed by the processor to maintain, update, and reference game state information and game progress information in association with user interactions.

The term “game event” refers to an occurrence in a game or interactive scenario that is triggered under certain conditions, such as reaching a location or obtaining a particular response, and that may change the game state.

The term “progress degree” refers to a quantitative or qualitative indicator of how far a user has advanced in a game or interactive process, which is updated in response to user actions and system outputs.

The term “reward information” refers to data representing benefits, points, items, or status given to a user as a result of achieving certain conditions or progressing in a game or interactive scenario.

In one embodiment, a server, a terminal, and an artificial intelligence device cooperate to provide location-based interactive guidance using a generative AI model. The server includes at least one processor, a main memory, a non-volatile storage device, and a network interface, and executes server-side software modules implementing position determination, prompt generation, interaction with a generative AI model, response verification and correction, history management, and game state management. The terminal includes a processor, a display, a user input interface, a location acquisition device such as a satellite positioning module or a wireless-based positioning module, and a network interface. The artificial intelligence device includes a processor, at least one of a sound output device and a display device, and a network interface, and operates as a physical information presentation apparatus such as a guide robot or an in-store kiosk.

The server executes an operating system such as a general-purpose server operating system and middleware such as a web server framework and an application server framework. The server further executes application programs implemented, for example, in a server-side language environment that provide an API endpoint for the terminal and the artificial intelligence device. The server mounts a relational database management system such as a general-purpose database system to store region information, product arrangement information, game state information, and history information. The server also exposes or consumes network-based APIs to and from an external generative AI model executed on a remote computing environment.

The terminal executes an operating system for mobile devices and a native or web-based application specifically designed to communicate with the server. The terminal uses an operating-system-level location acquisition API, such as a fused location provider interface or a location manager interface, to obtain position information from sensors including a satellite positioning receiver, a short-range wireless communication module, and an inertial sensor. The terminal uses an HTTP client library or a web communication stack to transmit position information and user-generated question information to the server. The terminal renders user interfaces using a GUI framework appropriate to the operating system and displays response sentences received from the server.

The user carries the terminal and moves within a physical facility. The user observes prompts on the terminal and on the artificial intelligence device, and inputs questions in natural language by entering text or by speaking into the terminal. The user can participate in a game-like experience in which the user's movement through regions of the facility and the user's questions cause events to occur and hints or rewards to be presented.

The server stores region information as a data structure in the database. In one example, the server defines each region by a region identifier, a set of two-dimensional or three-dimensional coordinate ranges, a floor number, and attributes such as a category label and a priority level. The server stores product arrangement information as records associating product identifiers with region identifiers and shelf identifiers. The server stores game state information as records associating user identifiers with current mission identifiers, mission progress values, and accumulated reward values. The server stores history information as records that link user identifiers to timestamps, position information, question information, prompt sentences sent to the generative AI model, and user-oriented response sentences transmitted back to the terminal and artificial intelligence device.

The server uses a position determination function implemented in software to compare position information received from the terminal with region information stored in the database. The server performs numeric calculations such as computing distances between the received coordinates and region boundaries, determining whether the coordinates reside within polygons or within preconfigured radius values. The server uses spatial indexing or clustering techniques in the database to accelerate these calculations. Because the server maintains region definitions and user position information in structured form, the server can efficiently determine which region the user occupies and can avoid unnecessary scanning of all region entries.

The server generates control information when the server determines that the user has reached a predetermined region. The control information contains event information specifying an event identifier, an event type such as “display guidance” or “trigger mission,” and parameters such as text content identifiers, reward values, or timing constraints. The server writes the control information to the database and transmits to the artificial intelligence device an output instruction that includes at least one of guidance information or game hint information. In one configuration, the artificial intelligence device receives the output instruction and presents related content by synthesizing speech through a text-to-speech engine and by displaying text and images on a graphical display.

The server interacts with a generative AI model that can be implemented, for example, as a large-scale neural network deployed on an external computing platform. In one embodiment, the generative AI model has an encoder-decoder or transformer-based architecture with a plurality of layers, each layer including attention mechanisms and feed-forward neural network blocks. The model parameters, which include weights and biases for each layer, are stored in a parameter store and have been learned by training the model on a large corpus of text data. During training, the generative AI model minimizes an objective function such as a cross-entropy loss between predicted token sequences and reference sequences, and updates its parameters using gradient-based optimization techniques such as stochastic gradient descent or its variants. The training process may use regularization, dropout, and data augmentation methods such as synonym replacement, paraphrasing, or shuffled sentence ordering to improve generalization performance.

The server uses a prompt generation function to assemble a prompt sentence to be input to the generative AI model. The server retrieves question information including the user's question sentence, and context information including the user's current region identifier, relevant product arrangement information, current game state information, and recent history information. The server composes these data elements into a textual prompt in which the server explicitly instructs the generative AI model about a role, constraint conditions, and an answer policy. By constructing the prompt sentence with structured context, the server modifies the probability distribution of possible output tokens from the generative AI model, thereby steering the model to produce responses that are more aligned with the physical environment and game state.

In one example, the server generates the following prompt sentence:

“You are an in-store guidance assistant operating in a physical retail environment. The user is participating in a game-like mission to find products. You must answer only about products that actually exist in the store layout and provide precise directions including floor number and section name. Current user region: second floor, electronics section. Available product categories nearby: smartphones, tablets, accessories. Game mission status: the user has not yet found the target product. User question: ‘I am looking for a new smartphone with a good camera. Where should I go?’ Please respond in one or two sentences with clear guidance using the store's region names.”

In another example, the server generates the following prompt sentence:

“You are a game mission guide in a physical entertainment facility. The user moves through zones and asks you for hints. You must use the given zone information and mission status, and you must not mention any internal system details. Current zone: gaming accessories corner. Active mission: ‘Find the mouse with the highest DPI.’ User question: ‘Can you give me a hint for this mission?’ Provide a brief, playful hint that directs the user toward a specific shelf or brand without revealing the answer directly.”

The server transmits the generated prompt sentence to the generative AI model through a network interface, using a request protocol such as HTTPS with a structured request payload including the prompt and generation parameters such as a maximum number of tokens, a temperature value controlling randomness, and a top-k or top-p constraint controlling token sampling. The generative AI model receives the prompt and processes it through its neural network layers, repeatedly computing attention scores, weighted sums of token embeddings, and linear transformations with non-linear activation functions. The model outputs a sequence of tokens representing the response sentence.

The server receives response information from the generative AI model and extracts the response sentence. The server then performs content verification processing. For example, the server parses the response sentence using a syntactic and semantic parser, extracts references to products, regions, or directions, and checks these references against product arrangement information and region information stored in the database. If the response sentence references a non-existent product or region, the server applies correction processing, such as substituting a valid product name or region name determined by the server's own database query. The server may also apply normalization rules to ensure that directional wording and formatting conform to predefined patterns.

The server generates a user-oriented response sentence as the result of the verification and correction operations. Because the server actively constrains and corrects the model output based on accurate database information, the overall system reduces erroneous responses and improves reliability compared with a naive configuration in which the model's output is used directly. This technical configuration leads to improved accuracy of guidance in the physical environment and minimizes the need for corrective user input.

The server transmits the user-oriented response sentence to the terminal and to the artificial intelligence device. The terminal receives the user-oriented response sentence and displays it in a text area or chat interface. The artificial intelligence device receives the user-oriented response sentence and performs multimodal output. For example, the artificial intelligence device may convert the text into audio using a speech synthesis module and present synchronized text and icon animations on its display. The artificial intelligence device may also adjust its orientation or movement by controlling motors and actuators according to information in the output instruction, thus physically indicating the direction of a target region or product.

The server stores, in a storage unit, history information including the position information, question information, prompt sentences, and user-oriented response sentences associated with each session or user. The server maintains this history in a structured format, such as a log table indexed by user identifier and timestamp. The server uses this history to update internal parameters controlling prompt generation and event selection. For example, the server may maintain a numeric score for each region indicating how often generative AI responses referencing that region required correction. The server may then adjust subsequent prompt sentences to include or exclude hints about that region, or to provide more explicit constraints, thereby reducing the probability of erroneous outputs. The server may also adjust the choice of events, such as which game missions to trigger, based on the user's past performance and the types of questions asked.

Because the server integrates position determination, game state management, prompt generation, and model output verification, the server reduces redundant computations and network calls. The server selectively invokes the generative AI model only when new context information or user questions justify a new response. The server caches intermediate results, such as frequent prompt templates and precomputed region descriptions, and reuses them when generating prompt sentences. This reduces the communication overhead with the external generative AI model and improves response time perceived by the user. The server's structured use of context and history enables more efficient handling of dialog states than systems that treat each question in isolation.

The use of the generative AI model in this system differs from human work automation because the server exploits model-specific controls and structured prompts to achieve a computational behavior that would be difficult to implement with manual rule authoring. The server encodes, in the prompt sentence, machine-readable constraints and histories that the model uses through its internal vector representations and attention mechanisms. The generative AI model evaluates rich prompt sentences and learns relationships among location context, game state, and natural language. As a result, the server achieves a high degree of context coherence in generated responses without requiring an exponential increase in rule complexity. This constitutes an improvement in computer technology as it allows complex context-dependent guidance to be generated with improved scalability, reduced rule maintenance, and more efficient usage of computation and storage.

In another embodiment, the server uses an alternative generative model suited for constrained device environments. For example, the server may employ a smaller neural network architecture with fewer layers and smaller embedding dimensions, or a hybrid model combining a rule-based template generator with a neural text completion module. The server may also adjust model parameters or selection strategies in real time, such as modifying temperature values based on a confidence score derived from history information. In these variations, the core functions of prompt sentence generation, context injection, output verification, and history-based update control remain, but the model architecture and its training regimes are tuned to specific hardware or latency requirements.

In another embodiment, the terminal performs additional pre-processing before sending question information to the server. The terminal may use an on-device language understanding module to classify user questions into categories and attach category labels to the question information. By providing this classification as part of the context information, the server can further reduce the search space of possible events and regions relevant to the answer, thereby improving processing speed and reducing communication load to the database.

In another embodiment, the artificial intelligence device includes additional sensors such as cameras and proximity sensors. The artificial intelligence device can detect the user's approximate direction relative to the device and use this information to orient its display or body. The server can instruct the artificial intelligence device, via output instruction information, to use specific gestures or movements when presenting guidance. This integration of sensor data and motor control with the generative AI-driven guidance further grounds the interaction in the physical environment and enhances the technical effect of providing location-aware assistance.

Across these embodiments, the server, terminal, and artificial intelligence device are configured to collaborate through concrete data structures, algorithms, and network communication, rather than merely automating human clerical tasks. The system improves technical performance by reducing incorrect responses through model-constrained prompts, by minimizing redundant model calls via history-aware processing, by optimizing database access with spatial indexing, and by coordinating physical device behavior with generated guidance, thereby providing a computer-implemented solution that enhances processing efficiency, response accuracy, and real-time interactivity in a location-based interactive guidance environment.

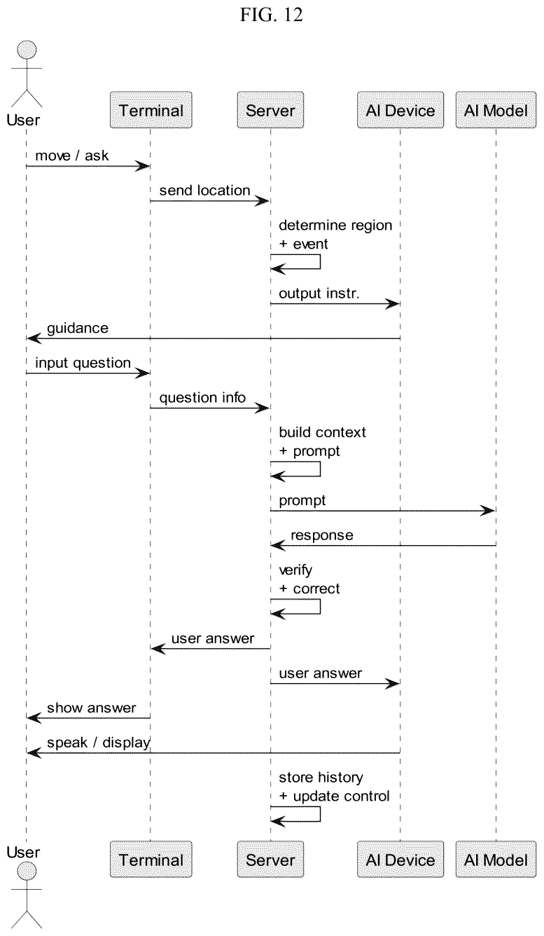

The following describes the processing flow using FIG. 12.

### Step 1

The terminal acquires position information of the user and sends it to the server.

The terminal uses a location acquisition device, such as a satellite positioning module or a wireless-based positioning module, and an operating-system-level location API to obtain raw sensor data (for example, latitude, longitude, accuracy, and timestamp).

Input: raw sensor readings from the location acquisition device.

The terminal converts the raw sensor readings into a normalized position information structure, including numeric coordinates and a device identifier, and serializes this structure into a message format such as JSON.

Output: a position information message transmitted from the terminal to the server via a network interface.

### Step 2

The server receives the position information message and determines a region occupied by the user.

Input: the position information message from the terminal.

The server parses the message to extract coordinates, user identifier, and timestamp. The server queries a region information storage unit, retrieving region records that contain region identifiers and geometric definitions. The server performs numeric computations, such as point-in-polygon checks or distance calculations, to determine whether the user's coordinates fall within any region boundary.

Output: a region determination result that includes a current region identifier or an indication that no region is matched.

### Step 3

The server generates event information and control information based on the region determination result.

Input: the region determination result from Step 2.

The server evaluates rules that map region identifiers to event types, such as “enter guidance zone” or “start mission.” The server creates event information that contains an event identifier, event type, and associated parameters. The server then assembles control information by attaching the event information to metadata including the user identifier and timestamp.

Output: control information specifying an event to be triggered for the user.

### Step 4

The server transmits output instruction information to the artificial intelligence device.

Input: control information including event information from Step 3.

The server selects or generates output instruction information that specifies guidance information or game hint information to be presented by the artificial intelligence device. The server may look up message templates or content records in a database and insert event-specific values into placeholders. The server sends the output instruction information to the artificial intelligence device via a communication function, encapsulating the instruction in a network message.

Output: a network message containing output instruction information delivered to the artificial intelligence device.

### Step 5

The artificial intelligence device prepares and performs information presentation based on the output instruction information.

Input: the output instruction information from the server.

The artificial intelligence device parses the instruction, extracts text content, presentation parameters (for example, priority and duration), and modality flags (for example, voice, text, or both). The artificial intelligence device loads the text content into a text-to-speech engine to synthesize an audio signal, and renders the same text on its display using a graphical user interface library. If movement instructions are included, the artificial intelligence device controls actuators to orient its body or display toward a specified direction.

Output: audio and/or visual output presented in the physical space to the user.

### Step 6

The user observes the presentations and inputs a question using the terminal.

Input: visual or audio guidance from the artificial intelligence device and the display interface on the terminal.

The user reads or listens to the hint or guidance and then decides on a question in natural language. The user enters the question by typing into a text field on the terminal or by speaking into the microphone. When speech is used, the terminal uses a speech recognition module to convert the audio signal into text.

Output: a question sentence captured in the terminal's application interface.

### Step 7

The terminal generates question information and transmits it to the server.

Input: the question sentence and current position information maintained by the terminal.

The terminal aggregates the question sentence, user identifier, optional category labels, and the latest position information into a structured question information object. The terminal serializes this object into a network message and sends it to an API endpoint on the server using an HTTP client.

Output: a question information message transmitted from the terminal to the server.

### Step 8

The server constructs context information associated with the question.

Input: the question information message from the terminal.

The server parses the question information to extract the question sentence, user identifier, and terminal-provided position information. The server queries the region information storage unit to confirm or update the user's current region. The server queries a product information storage unit to retrieve product arrangement information relevant to that region, and queries a game state storage unit to obtain current mission and progress values for the user. The server aggregates these data into context information that includes region identifiers, product categories, mission identifiers, and progress indicators.

Output: context information linked to the question sentence for the user.

### Step 9

The server generates a prompt sentence for a generative AI model.

Input: the question sentence and the context information from Step 8.

The server uses a prompt generation function to compose a textual prompt that encodes a role, constraint conditions, and an answer policy for the generative AI model. The server inserts the region description, product categories, mission status, and the user's question sentence into a fixed template. The server may also include instructions to restrict responses to known regions and products.

Output: a prompt sentence to be supplied to the generative AI model.

### Step 10

The server transmits the prompt sentence to the generative AI model and receives response information.

Input: the prompt sentence from Step 9 and generation parameters such as maximum token count and temperature.

The server forms a request payload containing the prompt sentence, token limits, and sampling parameters, and sends the payload to an external generative AI model via a network interface using a defined API. The generative AI model processes the prompt through its neural network layers and returns response information containing a generated response sentence and possibly auxiliary metadata such as token likelihoods. The server receives and parses the response.

Output: response information that includes a response sentence generated by the generative AI model.

### Step 11

The server performs content verification and correction on the response sentence.

Input: the response sentence from the generative AI model and internal database records.

The server analyzes the response sentence with a text parsing module to identify references to regions, floors, section names, and products. The server queries the region information storage unit and product information storage unit to verify that the referenced entities exist and are consistent with the user's current context. If a reference is incorrect or ambiguous, the server applies correction rules, such as replacing a general phrase with a specific, valid region label or substituting product names according to the current inventory.

Output: a corrected and verified response sentence suitable for presentation to the user.

### Step 12

The server generates a user-oriented response sentence and transmits it to the terminal and the artificial intelligence device.

Input: the corrected response sentence from Step 11 and presentation preferences.

The server formats the corrected response sentence, adding any necessary prefixes, line breaks, or labels, to create a user-oriented response sentence. The server then creates a response message for the terminal, including only the text and optional metadata such as emphasis markers or links, and a separate message for the artificial intelligence device, possibly including instructions for timing and modality. The server sends these messages through the communication function.

Output: a user-oriented response message delivered to the terminal and an output instruction message delivered to the artificial intelligence device.

### Step 13

The terminal displays the user-oriented response sentence to the user.

Input: the user-oriented response message from the server.

The terminal parses the message to extract the response text and associated metadata. The terminal updates the user interface to show the response in a dialog view or information panel. If the message includes structured data such as region identifiers, the terminal may render a map view or highlight a destination area on a floor plan. The terminal may also log the question and answer pair in a local log for immediate review.

Output: visual output on the terminal's display that presents the response sentence to the user.

### Step 14

The artificial intelligence device outputs the user-oriented response sentence in the physical environment.

Input: the output instruction message containing the user-oriented response sentence from the server.

The artificial intelligence device converts the text to speech with a speech synthesis engine to produce an audio waveform. The artificial intelligence device plays the waveform through a speaker and optionally displays the corresponding text on its screen. If the instruction includes motion directions, the artificial intelligence device commands motors to rotate or move toward the indicated direction, physically guiding the user.

Output: audio and visual feedback in the environment guiding the user according to the response.

### Step 15

The server records history information and updates internal control parameters.

Input: the position information, question information, prompt sentence, and user-oriented response sentence corresponding to the interaction.

The server aggregates these elements into a history record and stores the record in a history table indexed by user identifier and timestamp. The server may compute statistics such as how often corrections were applied to responses related to a particular region or product. Based on these statistics, the server updates weighting factors, thresholds, or template selections in the prompt generation function or in the event selection logic.

Output: updated history information in persistent storage and adjusted internal control parameters for future processing.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional location-based game systems typically use fixed, preauthored scripts and rule sets to present guidance or hints to a player. In such systems, a server receives location information from a terminal, determines a corresponding virtual area, and triggers a predetermined event, but the content delivered to the player is usually static and not adapted to fine-grained user progress or past interactions. As a result, the user experience tends to be repetitive, and the system cannot flexibly respond to a wide variety of natural-language questions from the user without extensive manual authoring and maintenance of dialogue trees.

Furthermore, in conventional architectures, any use of a generative AI model is often loosely coupled to the core game state management. For example, the generative AI model may generate free-form text answers without strict conditioning on the user's current virtual area, accumulated hints, or precise progress flags stored in the game database. This can produce answers that are inconsistent with the game design, reveal unintended information, or fail to guide the user appropriately. In addition, many existing systems do not systematically construct prompt sentences that encode structured context and output constraints for the generative AI model, resulting in unstable quality and style of AI responses.

From a computing technology perspective, there is also a problem that traditional server logic does not integrate continuous location acquisition, event triggering, dialogue generation, and progress updates into a unified, repeatable processing loop tied to real-time sensor data. This fragmentation makes it difficult to optimize server-side computation, cache usage, database access patterns, and network communication between the server and the terminal. Consequently, system resources are not efficiently utilized, and responsiveness and consistency of the interactive experience are degraded.

Accordingly, there is a need for an improved computer-implemented technique in which a processor on a server continuously acquires user location information from a terminal, determines virtual areas, triggers in-game events, constructs structured prompt sentences embedding area-specific and progress-specific context, invokes a generative AI model under explicit output constraints, and persistently updates and stores user progress information. Such a technique should tightly couple game state management with AI-based dialogue generation, thereby improving consistency, adaptability, and computational efficiency of interactive, location-linked game experiences.

The specific processing by the specific processing unit 290 of the data processing device 12 in Example 2 is realized by the following means.

The present invention provides a server comprising a processor and a storage device, the processor being configured to: receive authentication information of a user from a terminal, authenticate the user based on the authentication information, and control access of the user to a game field according to an authentication result; acquire location information of the user transmitted from the terminal, determine a virtual area to which the user belongs based on the location information, and trigger an in-game event according to at least one of an arrival of the user at the virtual area and a transition of the user between virtual areas; read progress information associated with the user from the storage device, update a game state of the user based on the location information and the progress information, and transmit the updated game state to the terminal; acquire question information input by the user through the terminal, and generate a prompt sentence based on the question information, the virtual area, and the progress information, the prompt sentence defining at least one of a role presented to the user, a dialogue style, and information to be withheld; transmit the prompt sentence and the question information as input data to a generative AI model, acquire response information generated by the generative AI model based on the prompt sentence, and transmit the response information to the terminal as utterance of an artificial intelligence character in a game; and update the progress information according to at least one of an occurrence of the in-game event and presentation of the response information, and store the updated progress information in the storage device. This enables tight integration of continuous location-based event control, structured prompt sentence construction for a generative AI model, and persistent progress management on the server side, thereby improving the consistency, adaptability, and computational efficiency of an interactive game system implemented on general-purpose computer hardware.

The term “processor” refers to a hardware computing element, such as a central processing unit or other programmable computation unit, configured to execute instructions stored in a memory to perform operations defined by software or firmware.

The term “storage device” refers to a hardware storage element, such as a semiconductor memory, magnetic storage, or optical storage, configured to store programs, game data, user data, progress information, and other information in a non-transitory manner.

The term “terminal” refers to an information processing device operated by a user, such as a portable communication device or other user equipment, configured to communicate with the server, present game content to the user, and transmit user input and sensor information to the server.

The term “user” refers to a human player who operates the terminal to access the game field, interact with game content, and provide inputs such as movement, selections, and natural-language questions.

The term “authentication information” refers to data used to verify an identity of the user, such as a user identifier, password, token, biometric information, or other credential transmitted from the terminal to the server.

The term “game field” refers to a virtual environment or logical space defined by game data, in which events, characters, and other game elements are arranged and with which the user interacts through the terminal.

The term “location information” refers to data indicating a physical position of the terminal associated with the user, such as geographic coordinates, altitude, or related positional attributes obtained from a positioning mechanism.

The term “virtual area” refers to a logically defined region within the game field, associated with at least part of the location information space, and used by the processor to determine which events, characters, or interactions should be made available to the user.

The term “in-game event” refers to a change of state or occurrence within the game field, such as appearance of a character, initiation of a dialogue, activation of a quest, or allocation of an item, triggered based on processing by the processor.

The term “progress information” refers to data indicating a current state of advancement of the user within the game, including at least one of visited virtual areas, completed events, obtained items, achieved milestones, and received hints.

The term “game state” refers to a collection of data representing a current configuration of the game as it relates to the user, including at least one of a current virtual area, active events, available interactions, progress information, and displayable content.

The term “question information” refers to natural-language input or equivalent query data provided by the user through the terminal, indicating a request for information, guidance, or interaction with a game element such as an artificial intelligence character.

The term “prompt sentence” refers to text data or structured textual content generated by the processor, including at least one of role instructions, dialogue style constraints, contextual information, and output requirements, and provided as input to a generative AI model to condition generation of response information.

The term “generative AI model” refers to a software-implemented machine learning model, such as a neural network trained on text data, configured to generate natural-language output based on input text including at least the prompt sentence and question information.

The term “response information” refers to natural-language text or other content generated by the generative AI model based on the prompt sentence and question information, and transmitted from the server to the terminal as an output to be presented to the user.

The term “artificial intelligence character” refers to a game entity represented within the game field, whose dialogue or behavior is at least partly controlled by response information generated by the generative AI model and presented to the user through the terminal.

The term “context information” refers to information included in or associated with the prompt sentence, comprising at least area information specific to the virtual area, hint information previously obtained by the user, and other state data used to condition operation of the generative AI model.

The term “area information” refers to data describing properties of a virtual area, such as an identifier, name, narrative attributes, permitted events, or restrictions, which can be used in the prompt sentence to constrain or guide responses of the generative AI model.

The term “hint information” refers to data representing guidance, clues, or partial answers previously provided to the user, used to adjust subsequent prompt sentences and response information so as to maintain consistency and avoid undesired repetition or excessive disclosure.

The term “output conditions” refers to parameters or constraints specified in the prompt sentence for the generative AI model, such as desired length, style, level of detail, prohibition of spoilers, or other formatting or content requirements for the response information.

In one embodiment, a server executes a game management program on a computer system including at least one processor, a main memory, a non-volatile storage device, and a network interface. The server is implemented, for example, on a general-purpose computer or a virtual machine executing an operating system such as a server-class operating system. The server communicates with one or more terminals via a network such as the Internet using a communication protocol such as HTTPS. Each terminal is implemented, for example, as a smartphone, tablet, or other mobile information processing device executing a mobile operating system such as a handheld device operating system.

The server stores, in the storage device, game data including definitions of a game field, a plurality of virtual areas, event definitions, progress information structures, and dialogue history records. The server also stores configuration information indicating parameters for a generative AI model, such as a model identifier, maximum token length, temperature, and safety constraints. The generative AI model is provided, for example, as a large-scale neural network for natural-language generation (such as a transformer-type language model) executed on a separate inference server or cloud service, and is accessible through an application programming interface.

The terminal includes at least one processor, a memory, a display device, an input device such as a touch panel, a microphone, a speaker, a wireless communication module, and a location acquisition module. The terminal uses a platform-provided location service (for example, a location service framework) and a global navigation satellite system receiver as GPS hardware to acquire latitude and longitude coordinates of the terminal. The terminal executes a game client program implemented, for example, by a game engine such as a cross-platform game engine or a native rendering framework, and displays a virtual scene corresponding to a virtual area within the game field on the display device.

The user operates the terminal to start the game client program, input authentication information, move in the physical world, and enter questions addressed to an artificial intelligence character. The user observes graphical representations of virtual areas and characters on the display, and receives audio feedback through the speaker. The user does not directly communicate with the server, but all user actions are transmitted to the server via the terminal.

The server controls user authentication by receiving, from the terminal, authentication information such as a user identifier and a password, and comparing the received information with authentication records stored in the storage device. The server uses a cryptographic hash function, such as a hashing algorithm with salting, to verify the password without storing it in plain text. The server generates, upon successful authentication, a session token that includes a user identifier, an expiration time, and signature data. The server transmits the session token to the terminal and uses the session token to identify the user in subsequent communications.

The terminal stores the session token in a secure storage area provided by the operating system and automatically attaches the session token to requests transmitted to the server. The server verifies the signature and validity period of the received session token in order to prevent unauthorized access. Through this configuration, the server securely associates location information, question information, and progress information with the correct user.

The server manages location information by receiving, from the terminal, position data including at least latitude and longitude, and optionally altitude, accuracy, and timestamp. The terminal acquires such data using the GPS hardware and location service, and converts the data into a compact data structure such as a key-value representation containing the coordinates and time. The server receives the position data via the network interface, stores the raw data or a filtered subset in a log table, and performs coordinate processing.

The server maps the position data to a virtual area by comparing the coordinates with area definitions stored in the storage device. The area definitions can be stored as records including, for each virtual area, an area identifier, a human-readable name, and geometrical data such as a set of polygon vertices or a rectangular bounding box in geographic coordinates. The server executes a geometric inclusion algorithm, such as a point-in-polygon test or a range comparison, to determine which virtual area contains the coordinates. The server thereby determines a current virtual area identifier for the user. This processing is executed using numerical comparison operations and vector operations on the processor, and is optimized by indexing the area definitions, for example by using spatial indexes in a database management system.

The server manages progress information by maintaining, in the storage device, a progress record for each user. The progress record includes at least a current virtual area identifier, completed quest flags, received hint identifiers, discovered items, and a timestamp of the last update. The server stores such progress records in a relational or document-oriented data store. The server reads the progress record when new location information or question information is received, and updates the record when events occur or new hints are delivered. The server writes the updated record back to the storage device. By doing so, the server ensures that a subsequent login or subsequent game session can resume from a consistent and exact state.

The server triggers in-game events based on the combination of virtual area and progress information. The server stores event definitions in the storage device, where each event definition includes an event identifier, a target virtual area, trigger conditions, and event actions. The trigger conditions may include, for example, the first arrival at a specific virtual area, the presence or absence of specific progress flags, or a count of previously provided hints. The event actions may include spawning an artificial intelligence character, unlocking a new area, starting a dialogue, or granting a virtual item.

The server, upon receiving updated location information, determines the current virtual area and compares it with the virtual area recorded in the user's progress. When the virtual area has changed or when a trigger condition is newly satisfied, the server selects an event definition whose conditions are satisfied. The server records that the event has been executed for the user and generates event output data, such as character identifiers, positions in the virtual area, and associated dialogue triggers. The server transmits this event output data to the terminal.

The terminal receives the event output data and instructs the game engine to render new objects, such as an artificial intelligence character appearing in a “Magic Forest” virtual area. The terminal uses texture mapping, animation, and sound output routines provided by the game engine to visually and audibly represent the event to the user. By associating the appearance of characters and events with real-world movement of the user, the system links physical movement to game control in a way that conventional static scripts cannot easily achieve.

The server controls dialogue with an artificial intelligence character by receiving question information from the terminal. The user enters a question using an input interface such as a text box or a microphone with speech-to-text conversion. The terminal converts the user's input into text data representing the question and transmits the question text along with metadata including the current virtual area identifier, an identifier of the addressed character, and the session token. The server stores the question text in a dialogue history table and associates it with the user and the current game state.

The server generates a prompt sentence for a generative AI model by combining the question text, the current virtual area, and the progress information. The server retrieves from the storage device the area information corresponding to the virtual area, including narrative attributes and restrictions (for example, “Magic Forest contains a hidden treasure that should not be fully disclosed at once”). The server also retrieves related hint information indicating which hints have already been delivered. The server then constructs a prompt sentence including role instructions, dialogue style constraints, and output conditions.

For example, the server may generate a prompt sentence in plain text as follows:

“You are an AI guardian character in the Magic Forest area of an adventure game. You know that there is a hidden treasure in this forest, but you must not reveal the exact location. The player has already received a first hint about following the fireflies. Speak in a slightly mysterious but friendly tone, and answer in one or two sentences. The player's question is: ‘I followed the fireflies, but I'm still lost. What should I do next?’”

In another example, when the user first enters the Magic Forest, the server may generate a prompt sentence as follows:

“You are an AI guardian character who appears when the player reaches the Magic Forest for the first time. You should provide an initial hint that suggests there is a hidden treasure in the forest, without revealing the exact position. Use simple and encouraging language, and answer in one or two sentences. The player's question is: ‘What is the secret of this forest?’”

The server constructs such prompt sentences as structured text containing multiple logical segments: an instruction describing the role, a description of area-specific context and available hints, an explicit list of prohibited disclosures, and a description of desired output conditions such as maximum length and tone. The server may internally store these segments in a data structure with fields such as “role_description,” “area_context,” “hint_history,” “constraints,” and “user_question,” and then linearize the fields into a single textual prompt sentence sent to the generative AI model. By doing so, the server enforces that the generative AI model operates under a consistent and constrained context, improving the determinism and reliability of the generated responses compared to direct free-form question answering.

The server communicates with the generative AI model using an API based on a request-response protocol over the network. The generative AI model is implemented, in one example, as a transformer-based neural network comprising multiple self-attention layers, feed-forward layers, normalization layers, and learned embeddings. The model parameters are learned in advance by training on a large corpus of text data representing dialogues, narratives, and instructions. During training, the model uses an objective function such as cross-entropy loss over token predictions, and the parameters are updated using a gradient-based optimization algorithm such as stochastic gradient descent with adaptive learning rate. The training process may also employ regularization techniques such as dropout and data augmentation such as paraphrasing to improve generalization.

The server sends the prompt sentence and the question text to the generative AI model as an input sequence of tokens. The generative AI model converts the tokens into embedding vectors, processes them through a stack of attention and feed-forward layers, and computes, for each position, a probability distribution over possible next tokens. The model then selects tokens according to the probability distribution under constraints such as temperature and maximum token count, thereby generating a response sentence one token at a time. This process is a sequence of floating-point matrix multiplications, additions, and non-linear transformations executed on specialized hardware such as graphics processing units. The server receives the generated tokens from the generative AI model and converts them back into text as response information.

The server post-processes the response information by applying rule-based filters, truncating overly long responses, and checking for violations of content constraints defined in the prompt sentence. For example, the server verifies that explicit coordinates or exact locations of a treasure are not included when the prompt sentence prohibits full disclosure. The server may strip or replace such content according to a dictionary or pattern list. The server stores the final response information in the dialogue history associated with the user and the current virtual area, and updates progress information such as a flag indicating that a second-stage hint has been delivered.

The terminal receives the response information and presents it as utterance of the artificial intelligence character. The terminal displays the text in a dialogue window, optionally synchronizing character facial animations or lip movements with the displayed text using the game engine. The user perceives that the artificial intelligence character is responding contextually and consistently with the game's narrative and previous hints.

The server improves computing efficiency and technical performance by structuring and caching context information used in the prompt sentence. The server stores, in the storage device, precomputed area context templates that include static parts of the prompt sentence for each virtual area. When generating a prompt sentence for a specific user, the server only fills variable segments such as reference to specific obtained hints and the user's current question. This reduces the amount of string processing required at runtime and reduces network payload size sent to the generative AI model. Additionally, by including only relevant context fields, the server shortens the input sequence length, which directly decreases the number of operations required by the neural network inference, thereby reducing latency and computational load.

The server also optimizes database access by grouping updates of progress information and event history into batched transactions. Instead of updating the progress record for every minor state change, the server aggregates multiple changes that occur within a short period and writes them in a single transaction. This reduces disk I/O and lock contention in the storage device, which results in faster response time and higher throughput. The server may maintain an in-memory cache of frequently accessed progress fields and area mappings in order to reduce repeated database queries.

The described configuration is not merely an automation of human game mastering or human dialogue creation. The server uses the generative AI model in a way that is structurally integrated with the internal state management of the game system. The prompt sentence explicitly encodes technical constraints, such as permissible and impermissible disclosures, and uses machine-interpretable structures stored in the storage device. This allows the server to systematically generate a variety of responses while ensuring that they remain consistent with complex internal states that would be impractical to track and enforce manually in real time. As a result, the system improves not only content diversity but also reduces inconsistency errors that often occur when human operators manage complex branching narratives.

Furthermore, the server realizes a technical improvement in how location-based inputs are used to drive computation. By transforming continuous GPS data into discrete virtual areas and associating these areas with event and dialogue logic, the server reduces the dimensionality of real-world coordinates into an efficient index space. This transformation decreases the complexity of game logic evaluation, enabling the processor to handle large numbers of users simultaneously. The continuous acquisition of location information and its integration into a unified processing loop with event triggering, prompt sentence generation, and progress updating result in an architecture that can be optimized for caching and load balancing, thereby enhancing overall processing speed and scalability.

Alternative embodiments are also possible. In one variation, the server uses a self-hosted generative AI model deployed on a local inference cluster instead of a remote cloud service, and applies quantization or model-distillation techniques to reduce model size and inference time. In another variation, the server uses different neural network configurations, such as an encoder-decoder architecture or a recurrent neural network, while still generating responses based on structured prompt sentences. The core idea of encoding game-specific constraints and progress context into the prompt sentence remains unchanged.

In another embodiment, the server includes additional rules for dynamically changing prompt sentence structure based on system performance conditions. For instance, when network latency to the generative AI model becomes high, the server can shorten prompt sentences by omitting less important context segments and reducing requested output length, thereby reducing the number of tokens processed and transmitted. This adaptive control directly reduces response time and conserves network bandwidth, demonstrating a technical effect on communication load.

In yet another embodiment, the terminal locally caches the latest response information and parts of the game state in order to minimize redundant server queries when the user repeats similar questions or returns briefly to a previously visited virtual area. The server and terminal coordinate cache validation using version numbers or timestamps. This cooperative caching mechanism reduces server processing load and network traffic, while maintaining consistency because the server remains the authoritative source of truth for progress information and event histories.

Through the above configurations, the server, the terminal, and the user cooperate in a system where the server performs structured context construction, efficient location-to-area mapping, constrained invocation of a generative AI model, and persistent state management. This provides a technically improved interactive game system that achieves enhanced processing speed, improved response consistency, and reduced communication and computation overhead compared to conventional systems that rely on static scripts or loosely coupled generative models.

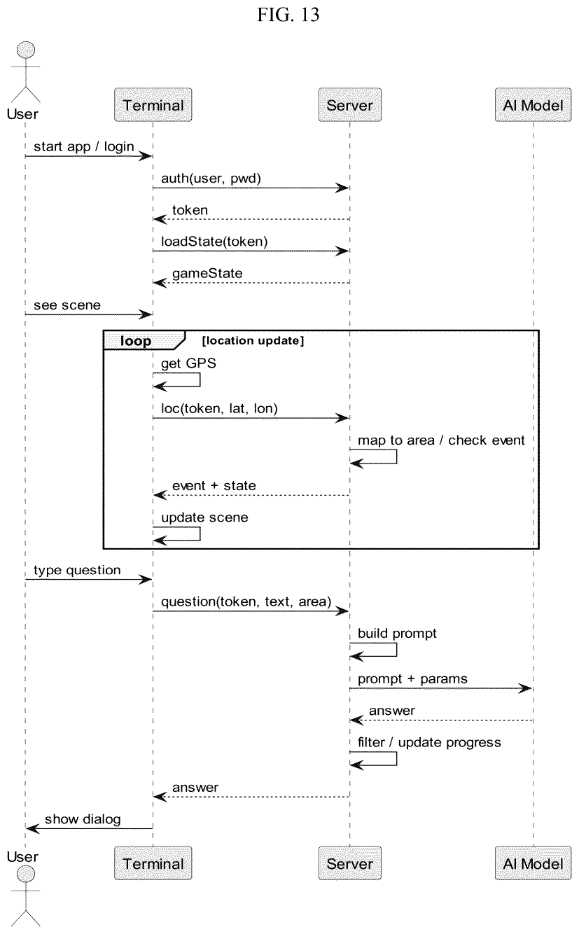

The following describes the processing flow using FIG. 13.

### Step 1

Server receives an authentication request from the terminal. The input is authentication information including at least a user identifier and a password, encapsulated together with device information. Server applies a hash function to the received password and compares the resulting hash value with a stored hash value retrieved from a user record in a storage device. Based on this comparison, server determines whether the user is valid. The output is an authentication result and, in case of success, a session token containing a user identifier and validity period, which server transmits back to the terminal.

### Step 2

Terminal stores the session token and initializes a game session. The input is the session token received from the server and any initial game configuration data. Terminal writes the session token into a secure storage area and configures an HTTP client to attach the token in an authorization header for subsequent requests. Terminal then sends a request to the server to load the current game state. The output of this step is a game state request message including the session token that is transmitted to the server.

### Step 3

Server loads the user's progress information and constructs an initial game state. The input is the game state request containing the session token. Server verifies the token, extracts the user identifier, and queries a progress table in the storage device to obtain fields such as current virtual area, active events, completed quests, and received hint flags. Server aggregates these fields into a structured game state object. The output is an initial game state dataset, which server sends to the terminal as a response.

### Step 4

Terminal renders the initial game scene based on the received game state. The input is the game state dataset received from the server, including a current virtual area identifier and associated presentation parameters. Terminal loads the corresponding scene assets using a game engine, positions the camera, initializes non-player characters, and configures user interface elements. The output is a displayed virtual scene on the terminal's display and an internal runtime state held in terminal memory that reflects the server-defined game state.

### Step 5

Terminal acquires physical location information of the user. The input is sensor readings from GPS hardware and an operating system location service, including latitude, longitude, and accuracy values. Terminal filters noisy readings by discarding measurements with low accuracy and averages multiple readings when necessary. Terminal packages the filtered coordinates with a timestamp and the session token. The output is a location update message that terminal transmits to the server via a network interface.

### Step 6

Server maps the received location information to a virtual area. The input is the location update message containing coordinates and a user identifier derived from the session token. Server retrieves virtual area definitions from the storage device, each definition including geometric data such as polygon vertices. Server executes a point-in-polygon algorithm or range checks to determine which virtual area contains the coordinates. Server may use precomputed spatial indexes to accelerate lookup. The output is a resolved virtual area identifier and, optionally, an indication of whether the user has changed areas compared to the previous state.

### Step 7

Server updates the user's game state and checks for event triggers. The input is the resolved virtual area identifier and the existing progress information for the user. Server compares the new virtual area with the previous virtual area stored in the progress record and determines whether an area transition has occurred. Server then evaluates event conditions by matching the virtual area, progress flags, and event definitions. This evaluation is done by executing conditional logic, such as checking whether a “first-visit” flag is false while the current area matches a specific target. The output is an updated game state that may include triggered event identifiers and updated progress flags.

### Step 8

Server generates event output data for the terminal. The input is the list of triggered events and the updated game state. For each triggered event, server reads associated event actions from an event definition table, including character identifiers, spawn positions, and start-dialogue flags. Server encodes these data into an event payload structure. The output is an event payload that server attaches to a response message and sends to the terminal together with the updated game state.

### Step 9

Terminal processes event payloads and updates the presented game scene. The input is the event payload and updated game state received from the server. Terminal instructs the game engine to instantiate character models, position them at specified coordinates in the virtual scene, and play associated animations and sounds. Terminal also updates user interface elements such as quest logs and notifications. The output is a modified visual and audio game presentation reflecting the newly triggered in-game events.

### Step 10

User interacts with an artificial intelligence character by providing a natural-language question. The input is the displayed game scene including the artificial intelligence character and a dialogue interface. User types a question through a text input field or speaks into a microphone, which is converted to text by a speech-to-text function on the terminal. The output is a question text string entered into the dialogue interface on the terminal.

### Step 11

Terminal prepares and sends question information to the server. The input is the question text string, the current virtual area identifier from the local runtime state, and the session token. Terminal constructs a dialogue request message that includes the question text and metadata such as the addressed character identifier. Terminal transmits this message to the server over the network. The output is a dialogue request received at the server side.

### Step 12

Server retrieves context information and constructs a prompt sentence. The input is the dialogue request containing the question text, user identifier, and current virtual area identifier. Server queries the storage device for area information, including narrative attributes and restrictions, and reads the user's progress information, including which hints have already been provided. Server combines these data to assemble a structured internal representation with fields for role description, area context, hint history, constraints, and the user's question. Server concatenates these fields into a single textual prompt sentence. For example, server may generate:

“You are an AI guardian character who appears when the player reaches the Magic Forest for the first time. You should provide an initial hint that suggests there is a hidden treasure in the forest, without revealing the exact position. Use simple and encouraging language, and answer in one or two sentences. The player's question is: ‘What is the secret of this forest?’”

The output is a prompt sentence string and associated question text prepared for input into the generative AI model.

### Step 13

Server invokes the generative AI model to generate response information. The input is the prompt sentence and question text, which server encodes into tokens using a tokenizer associated with the generative AI model. Server sends the tokenized sequence, along with parameters such as maximum output length and temperature, to an inference server hosting the generative AI model. The generative AI model performs a series of matrix multiplications, attention computations, and non-linear activations to compute probability distributions over possible next tokens at each generation step. The model selects tokens according to these probabilities under the specified parameters, thereby generating an answer sequence. The output is a sequence of tokens representing the generated answer, which server decodes back into human-readable response text.

### Step 14

Server post-processes the generated response and updates progress information. The input is the raw response text from the generative AI model and the current progress information of the user. Server examines the response text for prohibited content by applying pattern matching and rule-based filters that enforce the constraints encoded in the prompt sentence, such as prohibitions on disclosing exact treasure locations. If violations are detected, server removes or replaces inappropriate segments. Server then records, in the dialogue history, the association between the prompt sentence, the question text, and the final response text. Server updates progress information by setting flags indicating that a particular hint stage has been delivered. The output is sanitized response information and updated progress records stored in the storage device.

### Step 15

Server sends the response information and any updated game state to the terminal. The input is the sanitized response text and a summary of any state changes, such as new hints obtained or quests advanced. Server constructs a response message including the response text and identifiers for the speaking artificial intelligence character. The output is a dialogue response message transmitted to the terminal.

### Step 16

Terminal presents the response as utterance of the artificial intelligence character. The input is the dialogue response message received from the server. Terminal displays the response text in a dialogue window associated with the character and may synchronize facial expressions or gestures using animation controllers in the game engine. Terminal also updates local game state mirrors to reflect new hint flags or quest updates indicated by the server. The output is a visual and, optionally, auditory representation of the character's answer on the terminal screen.

### Step 17

Server periodically persists aggregated progress and optimizes resource usage. The input is a set of recent state changes including area transitions, triggered events, and delivered hints accumulated in memory. Server groups these changes into a batched database transaction and writes them to the storage device. This batch operation reduces the number of write operations and lock acquisitions compared to individual updates. The output is a consistent and compact representation of the user's current progress stored in persistent memory, which supports fast recovery and efficient query processing for subsequent requests.

### Step 18

User continues physical movement and dialogue interaction, and the loop of location updates, event triggering, prompt sentence generation, and generative AI model invocation repeats. The input at this stage is renewed location information and additional questions originating from the user as they explore new physical and virtual areas. The combined operation results in dynamic, context-sensitive content being produced automatically and efficiently by the server, while the terminal renders updated scenes and dialogues. The output is an ongoing interactive game experience that tightly couples the user's real-world movement with virtual events and AI-generated responses.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional interactive systems that provide game guidance or information assistance based on user location and user queries suffer from several technical limitations at the level of computer processing. First, such systems typically rely on statically authored hints or rule-based responses that are selected solely from pre-defined templates. As a result, the server cannot flexibly adapt the content, style, and level of detail of responses to dynamic, fine-grained context such as the user's current position, progress state, and emotional state. This leads to frequent mismatches between the information delivered and the user's actual needs, which in turn degrades system usability and increases unnecessary network traffic and processing retries caused by repeated help requests.

Second, in many existing architectures, user questions are simply forwarded as plain text to a language model or search engine without structured contextualization. Because the server does not systematically construct and manage prompt sentences that encode user intent, environmental context, and historical interaction state, the underlying models cannot reliably generate consistent, context-aware guidance. This lack of prompt control manifests as unstable response quality, redundant or irrelevant information, and increased computational overhead for repeated model calls, thereby wasting processing resources of the information processing device.

Third, multi-user scenarios and cooperative events are often implemented by duplicating independent single-user logic. The server does not maintain a unified view of multiple users'positions and progress states, nor does it generate differentiated prompts or responses per user in a coordinated manner. Consequently, the system is unable to efficiently orchestrate cooperative events, and the processor must execute ad-hoc, fragmented control flows, which complicates state management and increases the risk of inconsistent event triggering and data races.

Fourth, emotion information, when used at all, is usually processed as a separate, non-integrated feature. Existing systems may detect user emotion, but they do not systematically feed the detected emotional state back into the core response generation process. Thus, the processor is not configured to dynamically adjust prompt sentences and generated hints based on emotion, and cannot optimize the response generation pipeline in a closed loop. This results in repetitive or overly generic guidance, increased number of interactions needed for the user to reach a target state, and inefficient utilization of computational resources for both emotion analysis and natural language generation.

Accordingly, there is a need for an improved computer-implemented system and server-side control method that: (i) programmatically constructs and manages prompt sentences for a generative AI model using structured context including position, progress, and emotion; (ii) integrates emotion estimation into the core control loop to dynamically adjust response content and style; (iii) manages multiple users' states to orchestrate cooperative events while generating individualized prompts per user; and (iv) records and reuses interaction history to adjust subsequent prompt generation and event conditions. Such a system can improve the technical performance of interactive, location-aware, AI-driven services by stabilizing response quality, reducing redundant processing, and enabling more efficient control of generative models.

The specific processing by the specific processing unit 290 of the data processing device 12 in Application Example 2 is realized by the following means.

The present invention provides a server comprising a processor configured to acquire position information of a user who moves in a physical space or a virtual space via a portable information terminal, determine whether the user has reached a predetermined area based on the position information, and start an event when it is determined that the user has reached the predetermined area; construct, in response to starting the event, a prompt sentence to be input to a generative artificial intelligence model based on context information including at least information on the predetermined area, the event, and a behavior history of the user, transmit the prompt sentence to the generative artificial intelligence model so as to cause the generative artificial intelligence model to generate hint information, and cause an interactive information presentation apparatus to present the hint information to the user; generate, based on question information in natural language acquired from the user via the interactive information presentation apparatus and at least one of position information, context information, and progress information related to the question information, a prompt sentence for response generation by the generative artificial intelligence model, transmit the prompt sentence to the generative artificial intelligence model so as to cause the generative artificial intelligence model to generate response information, and cause the interactive information presentation apparatus to present the response information to the user; execute emotion estimation processing to estimate an emotional state of the user based on expression information and voice information acquired from an image acquisition apparatus and a sound acquisition apparatus, and dynamically change at least one of contents of the prompt sentence, a level of detail of the hint information and the response information, a representation style of the hint information and the response information, and a difficulty level of the hint information and the response information in accordance with the estimated emotional state; manage position information and progress information of a plurality of users, start a cooperative event based on the position information and the progress information of the plurality of users, individually generate, for each of the plurality of users participating in the cooperative event, a prompt sentence for the generative artificial intelligence model, and cause hint information or response information generated based on each prompt sentence to be presented in association with a corresponding interactive information presentation apparatus of each user; and record, as history information, the prompt sentences transmitted to the generative artificial intelligence model and the hint information or the response information acquired from the generative artificial intelligence model, and adjust at least one of generation of a subsequent prompt sentence and an appearance condition of a subsequent event based on the history information. This enables the server to implement an improved computer-controlled interaction pipeline in which prompt sentences for the generative artificial intelligence model are automatically constructed and adapted using structured context and emotion feedback, thereby stabilizing response quality, reducing redundant model invocations, coordinating multi-user cooperative events with individualized guidance, and enhancing overall processing efficiency and responsiveness of the interactive system.

The term “processor” refers to a hardware or virtual computation unit, such as a central processing unit or a processing core of an information processing device, that executes program instructions to perform the functions described in the present specification.

The term “user” refers to a human operator who interacts with the system via an input/output device, and whose position, behavior, queries, and emotional state are used as input data for the processing described herein.

The term “position information” refers to data indicating a location associated with the user, including at least one of geographical coordinates, area identifiers, or region identifiers within a physical space or a virtual space, which are used by the processor to determine whether the user has reached a predetermined area.

The term “physical space” refers to a real-world environment, such as a building, store, facility, or outdoor area, in which the user can move while carrying or wearing an information terminal.

The term “virtual space” refers to a computer-generated environment provided by a game system, simulation system, or information service, in which the user is represented by an avatar or other representation and whose virtual location is managed by the processor.

The term “portable information terminal” refers to an electronic device that can be carried or worn by the user, such as a handheld terminal or a head-mounted display, and that includes at least one input/output interface and a communication interface for exchanging data with the server.

The term “predetermined area” refers to a region in the physical space or the virtual space that is defined in advance in storage by region data, and used by the processor as a condition to trigger an event when the user's position information satisfies a predefined relationship with the region.

The term “event” refers to a processing sequence or state change controlled by the processor, including at least one of initiation of content presentation, activation of a game scenario, display of guidance, activation of a task, or start of an interaction with an artificial intelligence apparatus.

The term “context information” refers to structured data that characterizes a situation of the user or the system, including at least one of information related to the predetermined area, the event, the behavior history of the user, the progress information of the user, and the interaction history with the generative artificial intelligence model.

The term “behavior history” refers to recorded information indicating past actions of the user, including at least one of positions visited, events entered or completed, questions asked, responses received, and interaction timestamps stored by the processor.

The term “generative artificial intelligence model” refers to a learned model implemented by a program, such as a language model, configured to generate natural language or other content by probabilistically outputting data in response to an input prompt sentence.

The term “prompt sentence” refers to a text string constructed by the processor that serves as input to the generative artificial intelligence model and encodes at least part of the context information, user intent, control instructions, and desired characteristics of the output from the generative artificial intelligence model.

The term “hint information” refers to natural language content generated by the generative artificial intelligence model in response to a prompt sentence and presented to the user as guidance, advice, or cues for progressing in an event, game scenario, or information acquisition process.

The term “response information” refers to natural language content generated by the generative artificial intelligence model in response to a prompt sentence constructed from the user's question and related context, and presented as an answer or explanation to the user.

The term “interactive information presentation apparatus” refers to a device or functional module, including at least one display or sound output unit, that presents hint information or response information to the user and receives user input such as questions or commands in natural language.

The term “question information” refers to natural language data representing an inquiry from the user, obtained via speech input or text input, and used by the processor to construct a prompt sentence for the generative artificial intelligence model.

The term “progress information” refers to data indicating a state of advancement of the user within a scenario or process, including at least one of completed events, current objectives, remaining tasks, and stage identifiers maintained by the processor.

The term “image acquisition apparatus” refers to a hardware device such as an imaging sensor or camera that captures image data of at least the user's face or body for use in emotion estimation or interaction control.

The term “sound acquisition apparatus” refers to a hardware device such as a microphone that captures audio data of at least the user's voice for use in emotion estimation, speech recognition, or interaction control.

The term “expression information” refers to data representing features extracted from image data of the user's face or body, such as facial landmarks or expression attributes, which are used to estimate the emotional state of the user.

The term “voice information” refers to data representing features extracted from audio data of the user's speech, such as pitch, volume, prosody, and spectral characteristics, which are used to estimate the emotional state of the user or to decode the spoken content.

The term “emotion estimation processing” refers to a computational procedure executed by the processor or an associated module to infer an emotional state of the user from expression information and voice information using pattern recognition, statistical analysis, or a learned model.

The term “emotional state” refers to a classification or parameter set representing a psychological state of the user, such as confusion, enjoyment, boredom, or satisfaction, as estimated by the emotion estimation processing.

The term “representation style” refers to characteristics of the form in which hint information or response information is expressed, including at least one of tone, politeness level, narrative style, sentence structure, and degree of directness.

The term “difficulty level” refers to a parameter indicating complexity of content included in hint information or response information, including at least one of the number of steps, abstraction level, assumed knowledge, and challenge intensity.

The term “plurality of users” refers to two or more users who concurrently or sequentially interact with the system, such that their respective position information and progress information are managed together by the processor.

The term “cooperative event” refers to an event controlled by the processor that involves actions or states of a plurality of users, and whose initiation or progression depends on at least one of the combined position information and combined progress information of the plurality of users.

The term “history information” refers to stored data including at least prompt sentences transmitted to the generative artificial intelligence model and corresponding hint information or response information generated by the model, and optionally associated timestamps, user identifiers, and event identifiers.

The term “language analysis processing unit” refers to a functional module executed by software or hardware that analyzes natural language text to extract information such as intent, entities, and semantic roles, and that may implement dialogue management functions.

The term “intent information” refers to data indicating a purpose or goal underlying the user's natural language question, such as a request for location guidance, a request for explanation, or a request for recommendation, as derived by the language analysis processing unit.

The term “element information” refers to data representing specific parameters related to the user's question, such as object identifiers, area names, attributes, or conditions, extracted by the language analysis processing unit from the natural language input.

The term “game event” refers to a type of event that occurs within a game scenario managed by the processor, including at least one of starting a mission, opening a virtual object, initiating an encounter, or updating a game state.

The term “information provision process” refers to a control flow executed by the processor to provide non-game information to the user, including at least one of product information, guidance, instruction, or explanation, based on context information and responses generated by the generative artificial intelligence model.

The term “transition condition” refers to a condition evaluated by the processor to determine whether to move from one state, event, or process step to another, based on data including at least response information, position information, progress information, and history information.

In one embodiment, a server provides a system architecture in which a processor cooperates with a plurality of terminals and sensors to control location-aware, emotion-adaptive interactions using a generative AI model driven by structured prompt sentences.

### A. Overall Hardware and Software Configuration

A server includes at least one processor, a main memory, a non-volatile storage, and a network interface. The server runs an operating system such as a general-purpose server operating system and executes middleware including a web application framework, a relational database management system, and a model-inference runtime for a generative AI model. The server connects to terminals and auxiliary devices through a communication network such as a wireless network and a wired network.

A terminal includes a processor, a memory, a display, an audio output unit, a microphone, a camera, and a communication interface. The terminal is implemented as a portable device such as a handheld device or a head-mounted display. The terminal executes an application program that communicates with the server via a network protocol, acquires sensor data such as position information, image data, and audio data, and presents information to a user.

A user carries or wears the terminal while moving in a physical space or navigates a virtual space presented on the terminal. The user interacts with an interactive information presentation apparatus implemented by the terminal, by viewing or listening to output content and providing natural language input via speech or text.

### B. Generative AI Model and Prompt Sentence Control

The server stores or accesses a generative AI model implemented as a neural network, for example, a transformer-based language model comprising multiple self-attention layers, feed-forward layers, and embedding layers. The generative AI model is trained in advance on a corpus of natural language text using supervised learning and/or self-supervised learning. During training, the model minimizes a loss function such as a cross-entropy loss between predicted token probabilities and ground truth tokens, and updates network parameters by gradient-based optimization such as stochastic gradient descent or an adaptive optimization algorithm. The training process uses batched input sequences and may incorporate data augmentation techniques such as paraphrasing, random masking, or context shuffling to improve generalization.

The server configures the generative AI model for inference by loading trained parameters into a model runtime. The server controls the generative AI model by providing a prompt sentence as a sequence of tokens, together with generation parameters such as maximum output length, temperature, and sampling strategy. The server constrains the output of the generative AI model by encoding, in the prompt sentence, explicit instructions regarding style, length, difficulty level, and content restrictions. This control scheme causes the generative AI model to operate in a non-generic, constrained manner tailored to the system's state, rather than merely replicating conventional human-written text.

The server constructs the prompt sentence using a specific data structure. The server maintains a context object in memory for each user session, the context object including at least: (i) current position information, (ii) current event identifier, (iii) progress information, (iv) latest emotion state, and (v) history information including past prompt sentences and corresponding outputs. The server generates the prompt sentence by concatenating or templating multiple segments, such as:
(1) A system instruction segment defining the role of the model and general behavior.

Example:

“You are an AI guide that assists a user in a location-based interactive experience. Follow the instructions and context carefully.”

(2) A context segment describing the current area and event.

Example:

“The user has just entered an area called ‘magic forest’. The current event is ‘forest puzzle’. The user has already received one basic hint.”

(3) A user state segment describing progress and emotion.

Example:

“The user appears confused according to recent emotion analysis. The user has not yet found the north star.”

(4) A task instruction segment describing the required output characteristics.

Example:

“Generate a short, clear hint that helps the user move closer to the north star. Do not reveal the exact position. Use one or two sentences in simple language.”

The server then merges these segments into a single prompt sentence such as:

“You are an AI guide that assists a user in a location-based interactive experience. Follow the instructions and context carefully. The user has just entered an area called ‘magic forest’. The current event is ‘forest puzzle’. The user has already received one basic hint. The user appears confused according to recent emotion analysis. The user has not yet found the north star. Generate a short, clear hint that helps the user move closer to the north star. Do not reveal the exact position. Use one or two sentences in simple language.”

The server transmits this prompt sentence to the generative AI model and receives generated hint information. Because the server explicitly encodes technical state (position, progress, emotion, history) into the prompt sentence, the model's internal computations execute on a compact, state-rich representation rather than raw unstructured queries. This improves generation stability, reduces irrelevant content, and lowers the number of repeated calls required to obtain a useful response, thereby improving processing efficiency.

### C. Position Management and Event Control

The terminal acquires position information from a position sensor. In one embodiment, the terminal uses a satellite-based positioning module, a wireless access point based positioning system, or a short-range wireless beacon receiver. The terminal converts raw sensor readings into structured position information such as latitude, longitude, floor number, or zone identifier. The terminal periodically transmits the position information, together with a user identifier and a timestamp, to the server via a network.

The server stores area definitions and event conditions in a database. Each predetermined area is represented by a geometric shape (for example, polygon or circle) or a discrete zone identifier. Each event entry stores at least: an associated area, a trigger condition, a priority, and associated interaction templates. The server executes geometric computations or zone matching algorithms to determine whether a received position satisfies a trigger condition. When the user's position crosses a boundary into a predetermined area, the server changes the state of the event to active.

The server updates the context object for the corresponding user session to reflect the active event. The server then constructs a prompt sentence for the generative AI model as described above, incorporating event-specific instructions. For example, the server may generate a prompt sentence such as:

“The user has just reached the smartphone section of a store. The current objective is to recommend one smartphone model based on the user's stated preference for camera quality. Generate a brief recommendation in two sentences, mentioning one specific model and one key camera feature.”

By associating events with precise area definitions and state transitions in the server, the system ensures that prompt sentences are generated only when necessary, and only with relevant context. This reduces redundant processing and avoids unnecessary communication between the terminal and the server.

### D. Emotion Estimation and Adaptive Control

The terminal acquires image data and audio data from the camera and microphone. The terminal extracts low-level features such as facial landmarks, action units, pitch, intensity, and spectral coefficients. The terminal or the server processes these features using an emotion estimation model. In one implementation, the emotion estimation model is a neural network having convolutional layers for spatial feature extraction, recurrent or attention layers for temporal aggregation, and a final classification layer producing probability scores for multiple emotional states.

The emotion estimation model is trained with labeled data containing pairs of feature sequences and emotion labels. The training process minimizes a loss function such as categorical cross-entropy and updates weights using gradient-based optimization. The model is configured to output probabilities for classes such as “confused”, “engaged”, or “frustrated”. The terminal sends the estimated emotion state and associated confidence values to the server.

The server stores the emotion state in the context object, together with timestamps. The server then modifies the construction of prompt sentences using the emotion state. For example, when the emotion state indicates confusion, the server appends conditions such as:

“The user appears confused. Explain more slowly, use simple vocabulary, and include one intermediate step.”

When the emotion state indicates high engagement, the server appends conditions such as:

“The user appears highly engaged. Increase the challenge slightly by making the hint less explicit.”

By systematically feeding emotion state into prompt construction, the server alters internal generative AI model behavior in a way that directly reduces the number of iterations needed for the user to reach a goal. This, in turn, reduces model inference calls and overall computation time. The combination of emotion estimation and prompt adaptation thus provides a specific technical improvement to the server's control of the model and the efficiency of the data processing pipeline.

### E. Multi-User Management and Cooperative Events

The server manages multiple users by maintaining, in memory or storage, a session table mapping user identifiers to context objects. The server periodically updates each context object with new position information, progress information, and emotion states. The server executes a coordination algorithm that determines when a cooperative event should begin. For example, the server checks whether at least two users are simultaneously present in a shared area and whether each user has reached a specified progress threshold.

When a cooperative event is started, the server generates separate prompt sentences for each user, taking into account each user's position, progress, and emotion. For example, if a first user is ahead in progress, the server may generate a prompt such as:

“You are assisting a teammate who is slightly behind you. Provide a brief directional hint that helps your teammate reach your location, without revealing all puzzle details.”

For a second user who is behind, the server may generate:

“You are trying to catch up with your teammate. Ask the AI guide for a concise indication of where your teammate is located and one step you should take to move closer.”

This per-user differentiation ensures that the generative AI model generates outputs matching each user's role and state, improving coordination while limiting unnecessary data exchange. Because the server computes cooperative conditions based on numerical position data and discrete progress states, and then drives prompt generation accordingly, the system performs a non-conventional control flow that is tied to internal data structures rather than abstract human collaboration.

### F. Question Analysis and Intent Extraction

The user asks questions in natural language by speaking into the microphone or typing on the terminal. The terminal converts audio to text by executing a speech recognition model, for example a recurrent or transformer-based acoustic-to-text model, trained with paired speech and text data. The terminal transmits the text question to the server.

The server processes the text question using a language analysis processing unit, which may be implemented as a neural sequence classifier or a hybrid rule-and-model based intent recognizer. The language analysis processing unit tokenizes the input, extracts lexical features, and computes an intent label and element information such as referenced objects or areas. The model for intent recognition may be a transformer with a classification head, trained to minimize a classification loss over labeled intent categories.

The server combines the intent information and element information with context information (position, progress, history) and constructs a prompt sentence. For example, when the user asks “Where is the next event?”, the server generates:

“The user is asking for the location of the next event in the experience. The next event is located at the central square of the park. Explain in one simple sentence how the user can reach the central square from their current area, without giving precise coordinates.”

By performing structured intent extraction and context merging before invoking the generative AI model, the server reduces ambiguity in the model's input and constrains the model to relevant content. This leads to improved answer accuracy and shorter model-generated responses, which in turn reduce bandwidth usage and inference time.

### G. History Management and Adaptive Behavior

The server records every prompt sentence transmitted to the generative AI model and corresponding outputs (hint information and response information) in history information. The server also stores metadata such as timestamps and outcome indicators (for example, whether the user successfully completed the associated event). The server uses this history information to adjust subsequent prompt construction and event conditions.

For example, the server may detect that a specific pattern of prompt sentences often leads to user failure. In such a case, the server modifies templates to add more explicit explanations or additional intermediate hints. Conversely, if users repeatedly complete an event quickly, the server may adjust difficulty by modifying prompt sentences to be less explicit.

The server may implement a reinforcement-like heuristic that assigns scores to prompt patterns based on success metrics. These scores influence selection of templates and parameter settings when constructing future prompt sentences. Because the server applies these adjustments automatically based on stored history information, the system continuously optimizes its internal processing strategy, which yields improved computational efficiency and more stable user outcomes.

### H. Technical Effects and Improvements

The described system provides specific technical improvements beyond mere automation of human dialogue. The server performs structured context encoding into prompt sentences, emotion-aware adaptation, multi-user coordination, and history-based adjustment, which collectively optimize the execution of a generative AI model in a networked environment.

First, by constructing prompt sentences that explicitly incorporate position, progress, and emotion, the server reduces unnecessary branching in the model's internal search space. This reduces the length of generated responses, lowers token-level computation, and decreases latency and compute load.

Second, by using intent extraction and element extraction before invoking the generative AI model, the server transforms unstructured natural language input into structured data that guides the generative AI model. This pre-processing reduces model calls that would otherwise produce irrelevant content, thereby improving throughput and reducing error rates.

Third, by maintaining per-user context objects and history information, the server avoids reconstructing context from scratch on each request. This memory-based design reduces redundant database queries and expensive recomputation of high-level context, improving real-time responsiveness, especially in multi-user scenarios.

Fourth, by adapting prompt sentences based on emotion states and past outcomes, the server reduces the number of interactions required for users to complete tasks. This reduces overall data transfer and processing cycles, resulting in concrete improvements in communication load and processing efficiency.

Finally, the architecture emphasizes machine-internal data structures, numerical state transitions, and algorithmic decision-making for event control and prompt management. The system's behavior depends on technical considerations such as area geometry matching, neural model inference, context object management, and heuristic scoring over prompt patterns, rather than on mere replication of human conversational behavior. This provides a technical solution rooted in computer science and signal processing, and not a simple computerization of a human process.

### I. Alternative Embodiments and Variations

In another embodiment, the server executes the generative AI model locally on specialized hardware such as a graphical processing unit or a tensor processing unit. In such a case, the server loads a compressed or quantized model to reduce memory usage and inference time. The server may select between multiple generative AI models of different sizes based on context, for example using a smaller model for short hints and a larger model for complex explanations.

In another embodiment, the terminal performs part of the prompt generation locally. The terminal may maintain a simplified context object and generate local prompt fragments, which the server then merges with global context before sending to the generative AI model. This reduces server-side computation and network communication.

In yet another embodiment, the emotion estimation model and the intent recognition model are trained jointly or in a multi-task configuration, enabling the system to infer both intent and emotional state from the same input sequence. This unified model reduces feature extraction redundancy and improves prediction speed.

In each embodiment, the server, the terminal, and the user act in combination to realize a system in which a generative AI model is controlled by structured prompt sentences derived from technical state variables, thereby enabling efficient, adaptive, and context-aware interaction that improves the underlying computer processing itself.

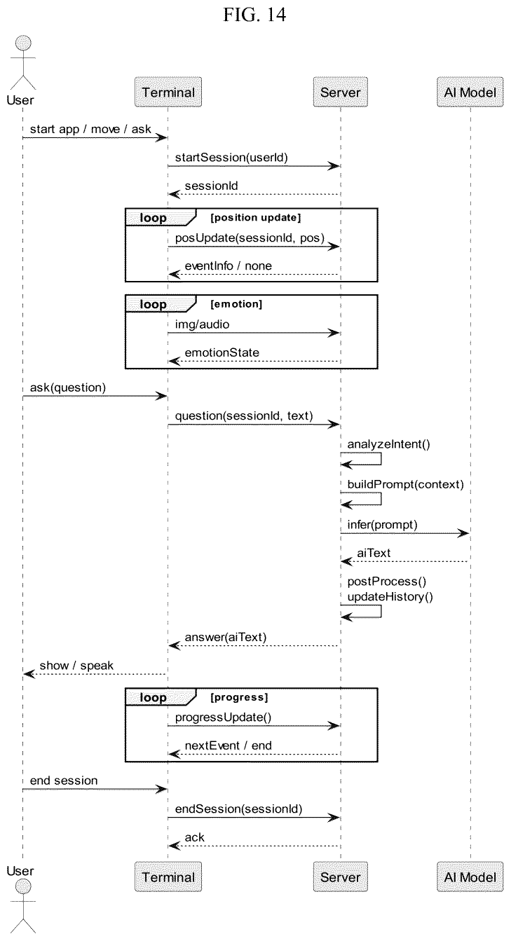

The following describes the processing flow using FIG. 14.

### Step 1

User activates application and starts a session.

User launches an application on the terminal and initiates a new interactive session.

Input: User touch input or voice command to start the application.

Output: A session start request message sent from the terminal to the server.

Terminal generates a unique session identifier, acquires a user identifier (for example, from stored credentials), and transmits a session start message including the session identifier and user identifier to the server.

### Step 2

Server initializes a context object for the session.

Server receives the session start message and allocates a context object in memory associated with the session identifier.

Input: Session start request containing the user identifier and session identifier.

Output: An initialized context object storing default position information, progress information, emotion state, and empty history information.

Server sets initial values, such as “no active event,” “no emotion detected,” and “initial progress stage,” and stores a reference to this object in a session management table.

### Step 3

Terminal acquires position information and sends it to the server.

Terminal activates a positioning module and reads raw sensor information, such as GPS coordinates, wireless access point signals, or beacon identifiers.

Input: Sensor readings from hardware sensors of the terminal.

Output: Structured position information including at least coordinates or zone identifiers and a timestamp, transmitted to the server.

Terminal executes a conversion process that maps raw sensor values into normalized coordinates or zone identifiers, encapsulates them in a position update message with the session identifier, and sends the message to the server over a network connection.

### Step 4

Server updates user position and detects entry into a predetermined area.

Server receives the position update message and retrieves the corresponding context object from memory.

Input: Position information including coordinates or zone identifiers and the session identifier.

Output: An updated context object with current position, and optionally an event activation flag.

Server performs a geometric computation or zone lookup, comparing the current position with area definitions stored in a database. If the user's position falls inside a predetermined area and the previous position did not, server sets an active event identifier in the context object and flags an event trigger.

### Step 5

Server selects event data and associated interaction parameters.

Server reads event configuration from the database for the active event identifier.

Input: Active event identifier stored in the context object.

Output: Event configuration data, including event name, objective, difficulty setting, and default interaction templates.

Server loads this event configuration into the context object and determines base parameters for generating hints, such as maximum hint length and default difficulty level.

### Step 6

Terminal acquires user image and voice data for emotion estimation.

Terminal activates the camera and microphone during user interaction and captures short segments of image frames and audio.

Input: Raw image data and raw audio data from the camera and microphone.

Output: Feature representations or compressed data sent to the server for emotion estimation.

Terminal extracts basic features, such as facial landmarks and audio pitch envelopes, and transmits either the features or compressed raw data with the session identifier to the server.

### Step 7

Server estimates the emotional state of the user.

Server receives image and/or audio feature data and feeds them into an emotion estimation model.

Input: Feature vectors derived from user facial expressions and voice tone.

Output: An estimated emotional state label (for example, “confused” or “engaged”) and associated confidence values, stored in the context object.

Server performs a forward pass of the emotion estimation neural network, calculates class probabilities, selects the highest probability label as the emotional state, and updates the context object with this label and probability.

### Step 8

User receives an initial hint and decides to ask a question.

User views or listens to a hint presented on the terminal and then decides to request additional information by voice or text.

Input: Previously displayed hint text and user decision to ask a question.

Output: A natural language question provided by the user to the terminal.

User speaks into the microphone or types on the keyboard, producing a raw question input that the terminal captures.

### Step 9

Terminal converts user question to text and sends it to the server.

Terminal records audio if the question is spoken and applies a speech recognition process to obtain textual content.

Input: Raw audio data or text entered by the user.

Output: A normalized question string transmitted to the server along with session and context identifiers.

Terminal may perform pre-processing such as noise reduction, tokenization, and normalization (for example, lowercasing and punctuation trimming) before encapsulating the question string in a request message.

### Step 10

Server analyzes the question and extracts intent and elements.

Server feeds the question text into a language analysis processing unit that performs intent classification and entity extraction.

Input: Question text and session identifier.

Output: Intent information (for example, “ask_next_event_location”) and element information (for example, target object or area), stored in the context object.

Server tokenizes the text, embeds tokens into vector representations, processes the sequence through an intent recognition model, calculates probabilities for predefined intent categories, selects the top intent, and extracts entities or parameters as element information.

### Step 11

Server gathers context information for prompt construction.

Server collects position information, progress information, emotion state, event configuration, and history information from the context object.

Input: Context object fields including current position, active event, progress state, emotion state, and past prompts and outputs.

Output: A structured internal context representation used for prompt sentence construction.

Server formats this context into a data structure that distinguishes between system-level instructions, environment description, user state, and output constraints.

### Step 12

Server constructs a prompt sentence for the generative AI model.

Server composes textual segments based on context, event configuration, intent, and emotion to create one coherent prompt sentence.

Input: Context representation and intent information.

Output: A prompt sentence string ready to be sent to the generative AI model.

Server concatenates or templates segments such as:
“You are an AI guide that assists a user in a location-based interactive experience.”
“The user is currently at the smartphone section of a store and wants to know the benefit of a specific product.”
“The product offers a 10% discount on the next purchase.”
“The user appears confused. Provide a clear, polite explanation in one sentence.”

Server joins these segments into a single prompt sentence like:

“You are an AI guide that assists a user in a location-based interactive experience. The user is currently at the smartphone section of a store and wants to know the benefit of a specific product. The product offers a 10% discount on the next purchase. The user appears confused. Provide a clear, polite explanation in one sentence.”

### Step 13

Server sends the prompt sentence to the generative AI model and receives generated text.

Server encodes the prompt sentence into tokens and performs an inference call to the generative AI model using a model runtime.

Input: Prompt sentence string and model configuration parameters such as maximum output length and temperature.

Output: Generated text representing hint information or response information.

Server feeds the tokenized prompt through the model's layers, allowing attention mechanisms to compute contextual representations, and samples output tokens according to the configured strategy until an end condition is met, then decodes tokens back into a natural language response.

### Step 14

Server post-processes the generated text and updates history information.

Server evaluates the generated text for length, style, and content constraints, and then stores it with the corresponding prompt sentence.

Input: Raw generated text and the original prompt sentence.

Output: Cleaned hint information or response information, and updated history records in the context object and/or database.

Server may trim overly long outputs, ensure that required elements such as the discount percentage appear, remove prohibited expressions if needed, and then append a record containing timestamp, prompt sentence, generated text, and outcome flags to the history information.

### Step 15

Server transmits the hint or response to the terminal.

Server encapsulates the processed hint or response text into a response message associated with the session identifier.

Input: Processed hint information or response information and session identifier.

Output: A network message containing the text to be delivered to the terminal.

Server uses a communication module to send the message via a protocol such as HTTP or a persistent connection such as WebSocket.

### Step 16

Terminal presents the generated information to the user.

Terminal receives the message and updates the user interface to show or read the content.

Input: Response message containing hint information or response information.

Output: Visual display or audio playback of the generated text to the user.

Terminal inserts the text into a chat window, overlays it in an augmented reality view, or applies a text-to-speech engine to convert the text into synthesized audio, and then plays it through the speaker so that the user can perceive the guidance.

### Step 17

User reacts based on the information and progresses in the event.

User observes or listens to the hint or answer and takes action in the physical space or virtual space, such as moving toward a described location or interacting with an object.

Input: Presented hint information or response information.

Output: User behavior that changes position, progress state, or subsequent questions.

User may reach a new area, complete a task, or decide to request additional assistance, thus influencing the next cycle of processing between the terminal and the server.

### Step 18

Server updates progress information and evaluates transition conditions.

Server receives new position updates or event completion signals from the terminal and uses them to update progress information in the context object.

Input: Latest position information and event completion indicators from the terminal.

Output: Updated progress state and, if conditions are met, a transition to a new event or scenario.

Server compares the updated position and event status against stored transition conditions. If all conditions for completing the current event are satisfied, server marks the event as completed, sets a new active event if applicable, and logs this transition in history information.

### Step 19

Server adapts subsequent prompt construction using history information.

Server analyzes accumulated history information for the session, including past prompts, generated outputs, emotion states, and success or failure outcomes.

Input: History information associated with the session and possibly aggregated statistics across sessions.

Output: Adjusted parameters or template selections for constructing future prompt sentences.

Server may, for example, increase or decrease the default level of detail in templates, adjust the number of steps described in hints, or alter style constraints to reduce user confusion. These adjustments change how the server constructs prompt sentences in future iterations, improving relevance and efficiency.

### Step 20

Terminal and server repeat the interaction loop until the session ends.

Terminal continues to send updated position, question, and sensor information, and server continues to generate context-aware prompt sentences and responses.

Input: Ongoing user actions, sensor data, and system state.

Output: A sequence of adaptive hints, answers, and event transitions up to session termination.

When the user ends the session, terminal sends a session termination message, and server finalizes storage of the context object and history information, optionally summarizing session statistics for later analysis.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

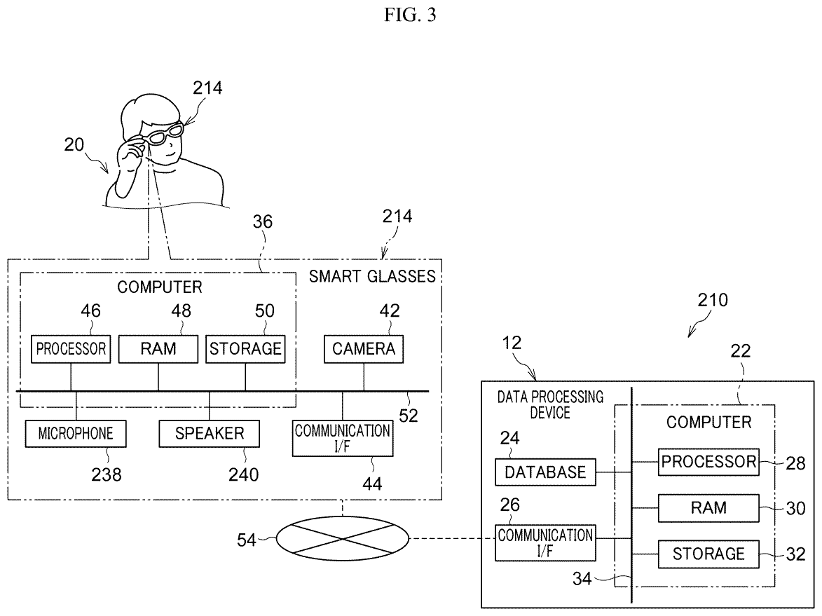

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

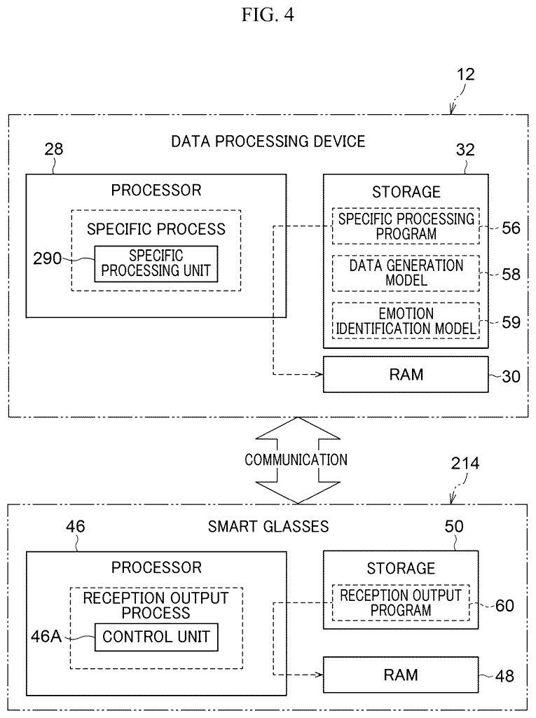

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

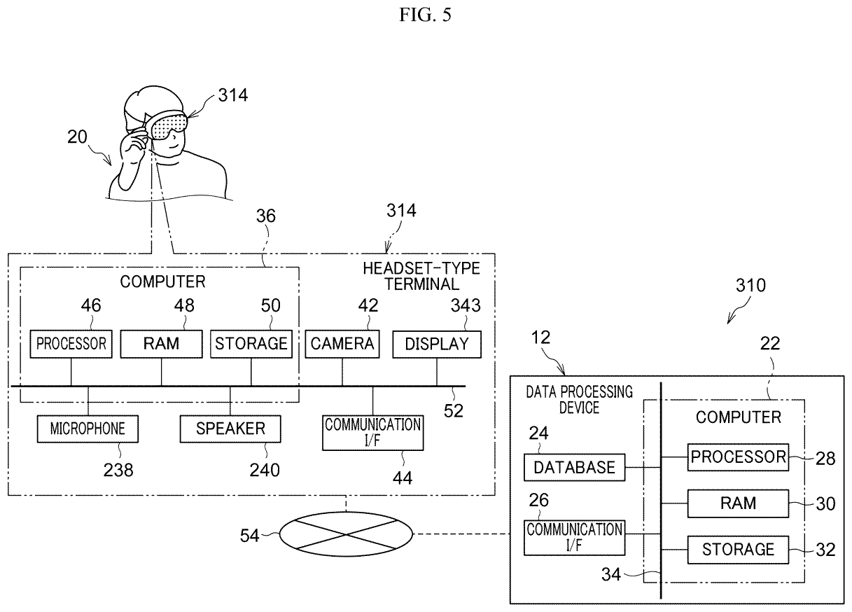

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

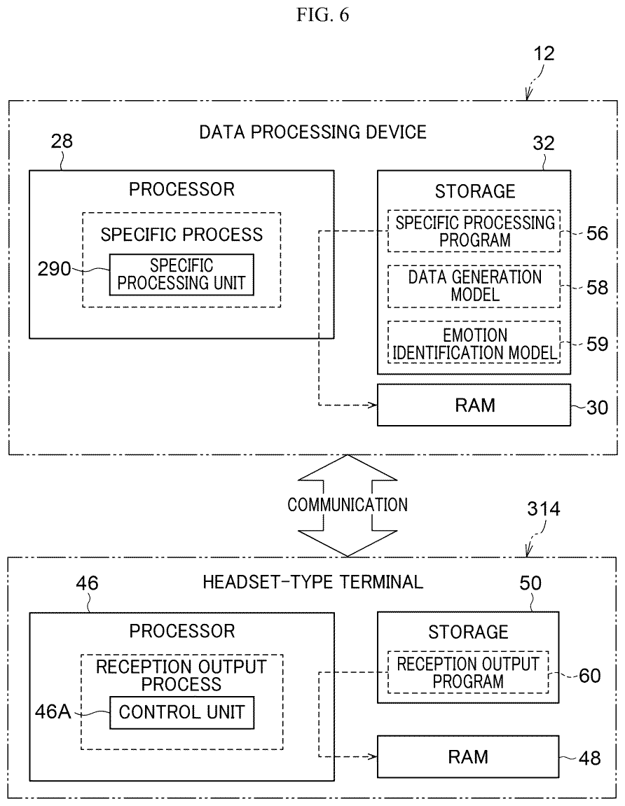

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

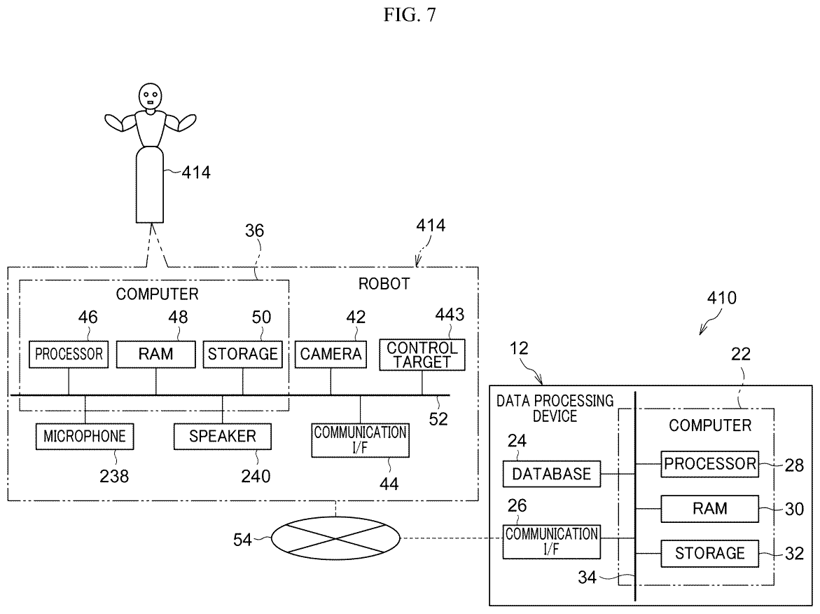

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

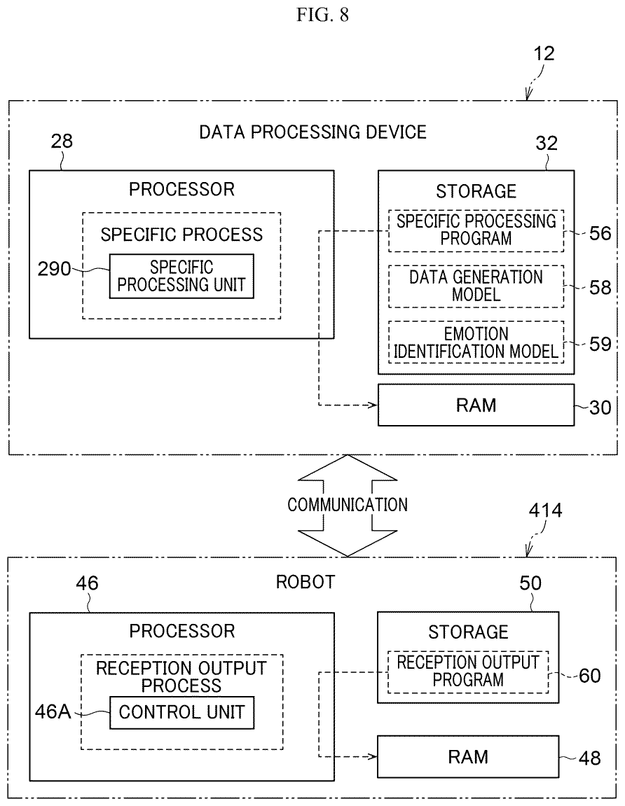

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

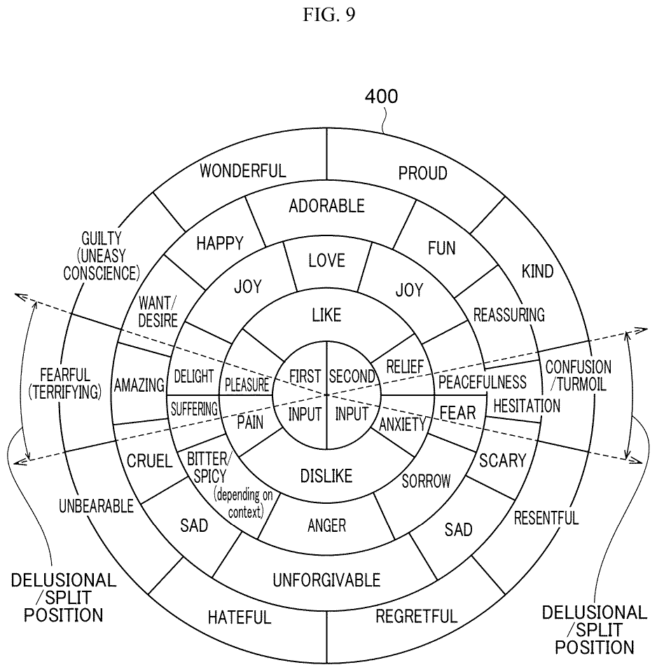

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

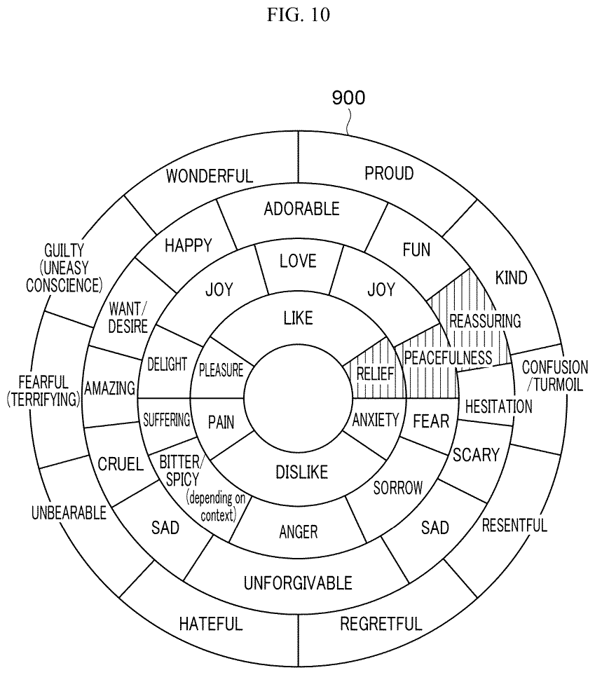

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor and a storage device,
wherein the processor is configured to
receive user identification information from an information processing terminal, compare the user identification information with authentication information stored in the storage device, and determine a usage authorization for a user,
receive location information of the user acquired by a location information acquisition unit of the information processing terminal, refer to a plurality of area information items stored in the storage device, determine whether the user has reached a predetermined area based on the location information and the plurality of area information items, and, when it is determined that the user has reached the predetermined area, cause a corresponding game event to occur,
acquire game state information stored in the storage device and the location information when the game event occurs, construct a prompt sentence to be input to a generative artificial intelligence model based on the game state information and the location information, transmit the prompt sentence to the generative artificial intelligence model, and obtain a response including hint information from the generative artificial intelligence model,
record, in association with the game state information and the location information, a natural language question input by the user and a past dialogue history, generate a prompt sentence to be input to the generative artificial intelligence model based on the question, the past dialogue history, the game state information, and the location information, and transmit a response obtained from the generative artificial intelligence model based on the prompt sentence to the information processing terminal, and
update a progress status of the user based on the game state information and generate guidance information regarding a next target point or a next game event, and transmit the guidance information to the information processing terminal.

### Supplementary 2

The system according to supplementary 1,
wherein the processor is configured to construct the prompt sentence as hierarchical text data including role information defining a role of the system, area information corresponding to a current position of the user, progress information corresponding to an achievement status of the user, and question content from the user, so as to cause the generative artificial intelligence model to generate hint information dependent on the position and the progress status.

### Supplementary 3

The system according to supplementary 1,
wherein the processor is configured to store, as the game state information, an occurrence history of the game event and a response history generated by the generative artificial intelligence model, generate different prompt sentences when the user reaches a same predetermined area a plurality of times based on the game state information, and thereby cause the user to participate in the game event while obtaining stepwise different hint information through dialogue with an artificial intelligence apparatus.

### Application Example 1

### Supplementary 1

A system comprising a processor,
wherein the processor is configured to
acquire position information of a user from a location acquisition device of a portable information terminal carried by the user, compare the acquired position information with a plurality of region information items stored in a region information storage unit by using a position determination function, determine whether the user has reached a predetermined region, and generate control information including event information in accordance with a result of the determination,
transmit, on the basis of the control information, output instruction information including guidance information or game hint information to be presented to the user to an artificial intelligence device having at least one of a sound output device and a display device, via a communication function, and control an information presentation operation of the artificial intelligence device,
generate, on the basis of question information including a question sentence received from the portable information terminal, and context information including the position information of the user and the event information, a prompt sentence to be input to a generative natural language processing model, by using a prompt generation function,
transmit the prompt sentence to an external generative natural language processing model,
acquire response information including a response sentence generated by the generative natural language processing model, perform predetermined content verification processing and correction processing on the response sentence, and generate a user-oriented response sentence by using a response generation function,
transmit the user-oriented response sentence to the portable information terminal via the communication function, and also transmit the user-oriented response sentence to the artificial intelligence device, and control display on the portable information terminal and output by the artificial intelligence device, and
store the position information, the question information, the prompt sentence, and the user-oriented response sentence as history information in a storage unit, and perform update control of generation of a subsequent prompt sentence or selection of subsequent event information on the basis of the history information.

### Supplementary 2

The system according to supplementary 1,
wherein the processor is configured to, when the question information from the user is received, generate, as the prompt sentence, a sentence including a role, constraint conditions, and an answer policy for the generative natural language processing model, on the basis of the question sentence included in the question information, region information to which the user belongs, game state information indicating a progress state of a game, and product arrangement information stored in a product information storage unit, and cause the generative natural language processing model to execute response generation processing by using the prompt sentence.

### Supplementary 3

The system according to supplementary 1,
wherein the processor is configured to associate a series of question information and position information obtained through interactions of the user with the portable information terminal and the artificial intelligence device with game progress information managed by a game state management function, record the associated information, and control occurrence of a game event, updating of a progress degree, and granting of reward information in a game in accordance with response information generated on the basis of the prompt sentence by the generative natural language processing model.

### Example 2

### Supplementary 1

A system comprising a processor and a storage device,
wherein the processor is configured to
receive authentication information of a user from a terminal, authenticate the user based on the authentication information, and control access of the user to a game field according to an authentication result,
acquire location information of the user transmitted from the terminal, determine a virtual area to which the user belongs based on the location information, and trigger an in-game event according to at least one of a arrival of the user at the virtual area and a transition of the user between virtual areas,
read progress information associated with the user from the storage device, update a game state of the user based on the location information and the progress information, and transmit the updated game state to the terminal,
acquire question information input by the user through the terminal, and generate a prompt sentence based on the question information, the virtual area, and the progress information, the prompt sentence defining at least one of a role presented to the user, a dialogue style, and information to be withheld,
transmit the prompt sentence and the question information as input data to a generative AI model, acquire response information generated by the generative AI model based on the prompt sentence, and transmit the response information to the terminal as utterance of an artificial intelligence character in the game, and
update the progress information according to at least one of an occurrence of the in-game event and presentation of the response information, and store the updated progress information in the storage device.

### Supplementary 2

The system according to supplementary 1,
wherein the processor is configured to
generate the prompt sentence as hierarchically structured text data including context information comprising area information specific to the virtual area and hint information previously obtained by the user, and output conditions required for the generative AI model, and cause the generative AI model to generate the response information including a hint corresponding to a progress state of the user based on the context information.

### Supplementary 3

The system according to supplementary 1,
wherein the processor is configured to
acquire the location information of the user transmitted from the terminal continuously or at predetermined intervals, and repeatedly execute determination of the virtual area, triggering of the in-game event, generation of the prompt sentence, generation of the response information by the generative AI model, and updating of the progress information each time the location information is acquired, thereby providing an interactive game experience linked to physical movement of the user.

### Application Example 2

### Supplementary 1

A system comprising a processor,
wherein the processor is configured to
acquire position information of a user who moves in a physical space or a virtual space via a portable information terminal, determine whether the user has reached a predetermined area based on the position information, and start an event when it is determined that the user has reached the predetermined area,
construct, in response to starting the event, a prompt sentence to be input to a generative artificial intelligence model based on context information including at least information on the predetermined area, the event, and a behavior history of the user, transmit the prompt sentence to the generative artificial intelligence model so as to cause the generative artificial intelligence model to generate hint information, and cause an interactive information presentation apparatus to present the hint information to the user,
generate, based on question information in natural language acquired from the user via the interactive information presentation apparatus and at least one of position information, context information, and progress information related to the question information, a prompt sentence for response generation by the generative artificial intelligence model, transmit the prompt sentence to the generative artificial intelligence model so as to cause the generative artificial intelligence model to generate response information, and cause the interactive information presentation apparatus to present the response information to the user,
execute emotion estimation processing to estimate an emotional state of the user based on expression information and voice information acquired from an image acquisition apparatus and a sound acquisition apparatus, and dynamically change at least one of contents of the prompt sentence, a level of detail of the hint information and the response information, a representation style of the hint information and the response information, and a difficulty level of the hint information and the response information in accordance with the estimated emotional state,
manage position information and progress information of a plurality of users, start a cooperative event based on the position information and the progress information of the plurality of users, individually generate, for each of the plurality of users participating in the cooperative event, a prompt sentence for the generative artificial intelligence model, and
cause hint information or response information generated based on each prompt sentence to be presented in association with a corresponding interactive information presentation apparatus of each user, and
record, as history information, the prompt sentences transmitted to the generative artificial intelligence model and the hint information or the response information acquired from the generative artificial intelligence model, and adjust at least one of generation of a subsequent prompt sentence and an appearance condition of a subsequent event based on the history information.

### Supplementary 2

The system according to supplementary 1,
wherein the processor is configured to add, to the prompt sentence to be input to the generative artificial intelligence model, condition information that defines at least one of an amount of explanation, a degree of guidance, a degree of challenge, and a degree of politeness of the hint information or the response information, based on at least one of the emotional state of the user, the position information of the user, and the progress information of the user, thereby controlling a style and contents of a natural language response output from the generative artificial intelligence model.

### Supplementary 3

The system according to supplementary 1,
wherein the processor is configured to input free-form question information in natural language acquired from the user to a language analysis processing unit having a dialogue processing function so as to extract intent information and element information, automatically generate the prompt sentence for the generative artificial intelligence model by combining the intent information and the element information with at least one of the position information, the progress information, and the history information, and determine a transition condition of at least one of a game event and an information provision process using the response information generated based on the prompt sentence.

What is claimed is:

1. A system comprising:
circuitry configured to:
receive, via a communication interface coupled to a packet-switched network, position data of a user from a terminal device;
compare the position data against a plurality of region data items stored in a storage device and determine whether the user has reached a predetermined region;
generate, upon determination that the user has reached the predetermined region, event control data corresponding to the predetermined region;
construct, based on the event control data, the position data, and state data stored in the storage device, instruction data for a generative model, and transmit the instruction data to the generative model to obtain context-dependent response data; and
transmit the context-dependent response data to the terminal device via the communication interface for presentation to the user.

2. The system according to claim 1, wherein the circuitry is configured to:
receive query data comprising a natural-language question from the terminal device,
generate a prompt sentence based on the query data, dialogue history data, the state data, and the position data, and
transmit the prompt sentence to the generative model to obtain the context-dependent response data.

3. The system according to claim 2, wherein the circuitry is configured to:
construct the prompt sentence as hierarchical text data comprising role information, region information corresponding to a current position of the user, progress information corresponding to an achievement status, and the query data.

4. The system according to claim 1, wherein the circuitry is configured to:
update a progress status of the user in the state data based on the event control data, and
generate guidance data indicating a next target region or a next event, and transmit the guidance data to the terminal device.

5. The system according to claim 1, wherein the circuitry is configured to:
store the position data, the query data, the instruction data, and the context-dependent response data as history data in the storage device, and
modify generation of subsequent instruction data based on the history data.

6. The system according to claim 5, wherein the circuitry is configured to:
generate different instruction data when the user reaches the same predetermined region a plurality of times, based on accumulated history data, so that the context-dependent response data varies across visits.

7. The system according to claim 1, wherein the circuitry is configured to:
transmit the event control data to an output device coupled to the packet-switched network to cause the output device to present guidance information associated with the event control data.

8. The system according to claim 7, wherein the output device comprises at least one of a sound output device or a display device positioned at or near the predetermined region.

9. The system according to claim 1, wherein the circuitry is configured to:
receive authentication data from the terminal device,
compare the authentication data against credential data stored in the storage device, and
determine a usage authorization for the user prior to processing the position data.

10. The system according to claim 1, wherein the circuitry is configured to:
perform content verification processing and correction processing on the context-dependent response data obtained from the generative model before transmitting the context-dependent response data to the terminal device.

11. The system according to claim 1, wherein the position data comprises at least one of GPS coordinates, indoor positioning data, or beacon-derived proximity data received from a location acquisition unit of the terminal device.

12. The system according to claim 1, wherein the circuitry is configured to:
estimate an affective state of the user based on at least one of text data, audio data, or image data received from the terminal device, and
adjust at least one of a tone or a content focus of the context-dependent response data based on the estimated affective state.

13. The system according to claim 1, wherein the generative model comprises a transformer-based language model, and the circuitry is configured to:
tokenize the instruction data into token sequences, and
transmit the token sequences to the transformer-based language model via the communication interface.

14. The system according to claim 1, wherein the circuitry is configured to:
manage a plurality of predetermined regions, each associated with respective event control data and state transition rules, in the storage device, and
trigger different events based on which predetermined region the user has reached.

15. The system according to claim 1, wherein the circuitry is configured to:
generate report data aggregating position data, event occurrences, and dialogue interaction records over a specified period, and
transmit the report data to a management terminal device via the communication interface.

16. The system according to claim 1, wherein the terminal device comprises at least one of a mobile computing device, a wearable display device, a headset-type terminal, or a robotic apparatus, each coupled to the packet-switched network via the communication interface.

17. The system according to claim 16, wherein the terminal device comprises the wearable display device including a microphone and a speaker, and the circuitry is configured to:
receive audio data representing user speech from the wearable display device, and
transmit audio output data to the speaker of the wearable display device based on the context-dependent response data.

18. The system according to claim 1, wherein:
the circuitry comprises a processor, a memory storing a program, a communication interface, and a storage device,
the processor executes the program to implement the comparison of the position data and the construction of the instruction data,
the storage device stores the region data items, the state data, and the history data, and
the communication interface exchanges data with the terminal device over the packet-switched network.

19. The system according to claim 18, wherein the storage device comprises a region database that associates region identifiers with boundary coordinates, event definitions, and state transition rules.

20. A method performed by circuitry, the method comprising:
receiving, via a communication interface coupled to a packet-switched network, position data of a user from a terminal device;
comparing the position data against a plurality of region data items stored in a storage device and determining whether the user has reached a predetermined region;
generating, upon determination that the user has reached the predetermined region, event control data corresponding to the predetermined region;
constructing, based on the event control data, the position data, and state data stored in the storage device, instruction data for a generative model, and transmitting the instruction data to the generative model to obtain context-dependent response data; and
transmitting the context-dependent response data to the terminal device via the communication interface for presentation to the user.
